(19) United States
(12) Patent Application Publication
(10) Pub. No.: US 2024/0422621 A1
(43) Pub. Date: Dec. 19, 2024

(54) METHODS, ARCHITECTURES, APPARATUSES AND SYSTEMS FOR MULTI-FLOW SYNCHRONIZATION

(71) Applicant: InterDigital Patent Holdings, Inc., Wilmington, DE (US)

(72) Inventors: Jaya Rao, Montreal (CA); Senay Negusse, Montreal (CA); Tejaswinee Lutchoomun, Montreal (CA); Ghyslain Pelletier, Montréal (CA); Caroline Baillard, Saint Sulpice La Foret (FR); Vincent Alleaume, Pace (FR); Nicolas Mollet, Meillac (FR); Anthony Laurent, Vignoc (FR); Janet Stern-Berkowitz, Little Neck, NY (US); Benoit Pelletier, Roxboro (CA)

(21) Appl. No.: 18/706,180

(22) PCT Filed: Nov. 1, 2022
(86) PCT No.: PCT/US2022/048575

§ 371 Date: Apr. 30, 2024

Related U.S. Application Data
(60) Provisional application No. 63/275,133, filed on Nov. 3, 2021.
(60) Provisional application No. 63/335,285, filed on Apr. 27, 2022.

(51) Int. Cl. H04W 28/12

(52) U.S. Cl. CPC H04W 28/12

(57) ABSTRACT

Procedures, methods, architectures, apparatuses, systems, devices, and computer program products are described for the synchronization of multiple traffic flows of information such as protocol data unit (PDU) flows associated with applications and/or services. In an example embodiment, a device may receive one or more forwarding configurations to use when transmitting data in multiple flows. The forwarding configurations may lead to synchronized transmission of the multiple flows such that a delay between a (e.g., last or latest) PDU in a first flow and a (e.g., last or latest) PDU in a second flow satisfies one or more parameters, such as different expected time of arrival threshold values. In some embodiments, PDUs may be associated with an application data unit (ADU) in the first flow and an ADU in the second flow.

### CROSS-REFERENCE TO RELATED APPLICATIONS

This application claims the benefit of U.S. Provisional Patent Application Nos. (i) 63/275,133 filed 3 Nov. 2021, and (ii) 63/335,285 filed 27 Apr. 2022; each of which is incorporated herein by reference.

### BACKGROUND

The present disclosure is generally directed to the fields of communications, software and encoding, including, for example, to methods, architectures, apparatuses, systems directed to ensuring synchronization of multiple data flows, such as multiple data flows related to extended reality (XR) communications.

### SUMMARY

In certain representative embodiments, a wireless transmit/receive unit (WTRU) may determine a resource (e.g., forwarding) configuration to use when transmitting and/or receiving multiple flows (e.g., in the uplink and/or downlink) to synchronize transmission. The multiple flows may, for example, be synchronized such that a delay between a (e.g., latest) protocol data unit (PDU) in a first flow and a (e.g., latest) PDU in a second flow is less than or equal to different expected time of arrival (ETA) threshold values, such as an inter-flow packet delay budget (PDB). For example, the PDUs in the first and second flows may be received from any of an application and/or service (e.g., which generates information in a payload of the PDUs) executed by the WTRU, another WTRU, a base station and/or a network entity.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of multi-flow synchronization that may be used within the communications systems described herein;

FIG. 3 is a system diagram illustrating another example of multi-flow synchronization that may be used within the communications systems described herein;

FIG. 4 is a system diagram illustrating a further example of multi-flow synchronization that may be used within the communications systems described herein;

FIG. 5 is a procedural diagram illustrating an example procedure for synchronizing multiple flows;

FIG. 6 is a procedural diagram illustrating another example procedure for synchronizing multiple flows;

FIG. 7 is a procedural diagram illustrating an example procedure for synchronizing multiple flows;

FIG. 8 is a procedural diagram illustrating another example procedure for synchronizing multiple flows;

FIG. 9 is a procedural diagram illustrating an example for transmitting multiple flows using priority levels;

FIG. 10 is a procedural diagram illustrating an example for receiving multiple flows using priority levels;

FIG. 11 is a procedural diagram illustrating an example procedure for adjusting resource configuration information for synchronizing multiple flows;

FIG. 12 is a procedural diagram illustrating another example procedure for adjusting resource configuration information for synchronizing multiple flows;

FIG. 13 is a procedural diagram illustrating a further example procedure for adjusting resource configuration information for synchronizing multiple flows;

FIG. 14 is a procedural diagram illustrating an example procedure for adjusting resource configuration information for synchronizing multiple flows;

FIG. 15 is a procedural diagram illustrating another example procedure for adjusting resource configuration information for synchronizing multiple flows;

FIG. 16 is a procedural diagram illustrating a further example procedure for adjusting resource configuration information for synchronizing multiple flows;

FIG. 17 is a procedural diagram illustrating an example procedure for maintaining a joint Quality of Service (QoS) for multiple flows;

FIG. 18 is a procedural diagram illustrating another example procedure for maintaining a joint Quality of Service (QoS) for multiple flows;

FIG. 19 is a procedural diagram illustrating further example procedure for synchronizing multiple flows;

FIG. 20 is a procedural diagram illustrating a further example for transmitting multiple flows using priority levels;

FIG. 21 is a procedural diagram illustrating a further example procedure for adjusting resource configuration information for synchronizing multiple flows; and

FIG. 22 is a procedural diagram illustrating an example procedure for maintaining a joint Quality of Service (QoS) for multiple flows.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

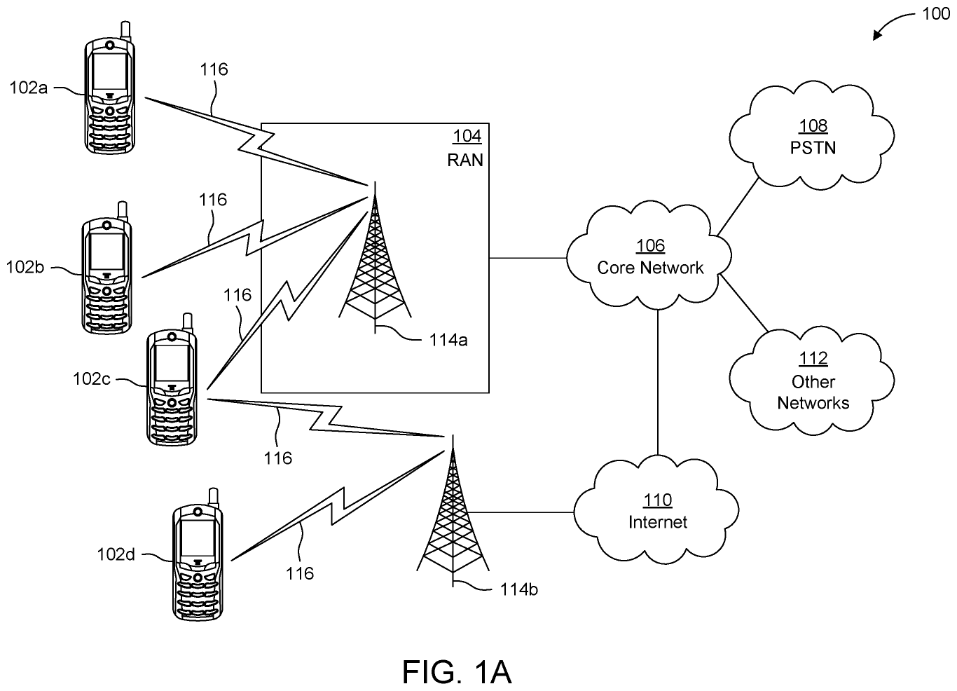

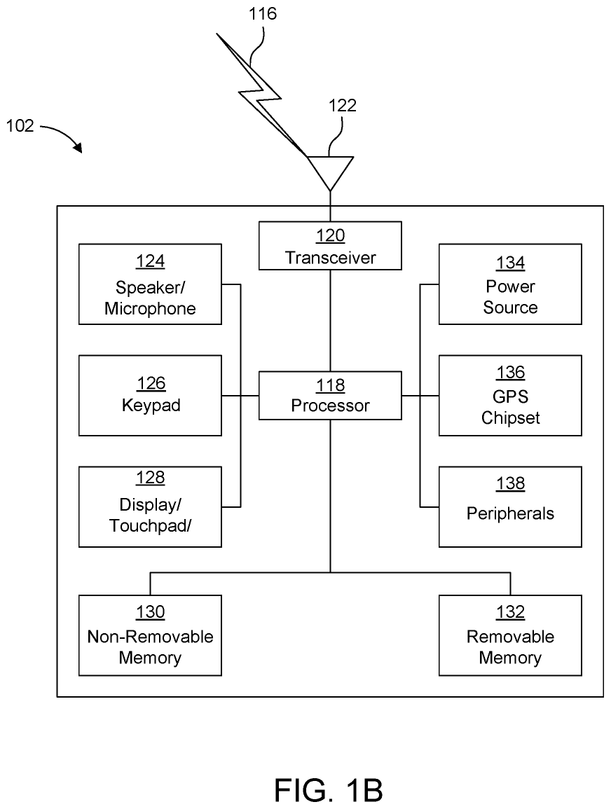

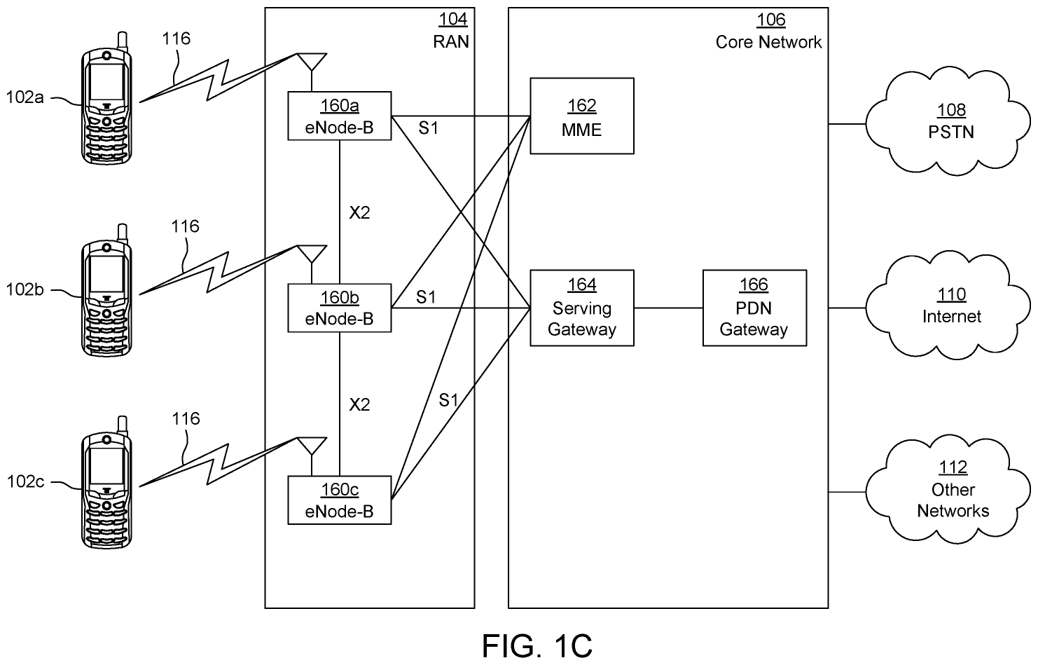

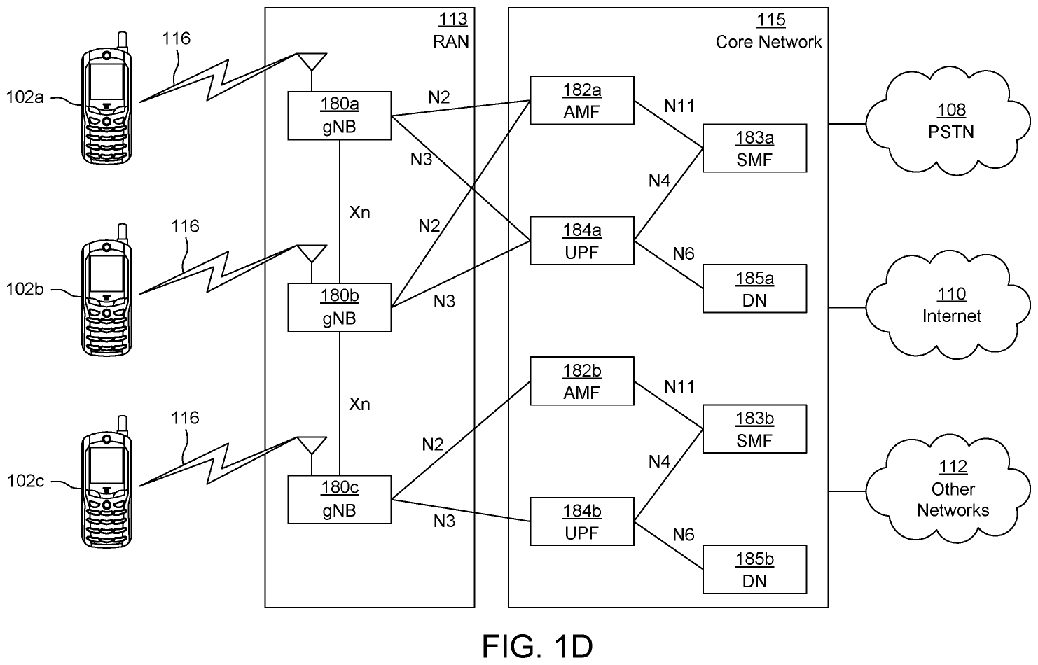

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations may be used herein as follows:
6DOF 6 Degrees of Freedom
ACK Acknowledgement
ADU Application Data Unit
AR Augmented Reality
BWP Bandwidth Part
CSI Channel State Information
CG Cloud Gaming
DL Downlink
DMRS Dedicated Demodulation Reference Signals
FDD Frequency Division Duplex
FoV Field of View
gNB NR Node B
fps Frames per second
HARQ Hybrid Automatic Repeat reQuest
iBLER initial Block Error Rate
LCH Logical Channel
MCS Modulation and Coding Scheme
MTP Motion-to-photon
NACK Negative Acknowledgement
PDCCH Physical Downlink Control Channel
PDB Packet Delay Budget
PDU Packet Data Unit
PER Packet Error Rate
PSG Power Saving Gain
PSR Packet Success Rate
PUCCH Physical Uplink Control Channel
PUSCH Physical Uplink Shared Channel
PDSCH Physical Downlink Shared Channel
RTT Round trip time
SR Scheduling Request
STD Standard Deviation
TDD Time Division Duplex
UE User Equipment
UL Uplink
VR Virtual Reality
XR Extended Reality

### SUMMARY

In certain representative embodiments, a WTRU may determine a resource (e.g., forwarding) configuration to use when transmitting and/or receiving multiple flows (e.g., in the uplink and/or downlink) to synchronize transmission. The multiple flows may, for example, be synchronized such that a delay between a (e.g., latest) PDU in a first flow and a (e.g., latest) PDU in a second flow is less than or equal to different expected time of arrival (ETA) threshold values (e.g., an inter-flow PDB). For example, the PDUs in the first and second flows may be received from any of an application and/or service (e.g., which generates information in a payload of the PDUs) executed by the WTRU, another WTRU, a base station and/or a network entity.

For example, a WTRU may be configured to perform any of the following:
Receiving information (e.g., configuration information), from a base station (e.g., gNB), indicating primary and secondary ETA threshold values (e.g., time instances and/or durations) and one or more forwarding configurations associated with different priorities (e.g., at least one default forwarding configuration (e.g., logical channel (LCH)) per flow for forwarding PDUs in each flow with a default priority value);
Receiving a PDU associated with a first flow (e.g., ‘flow 1’) and/or sending the PDU using a default forwarding configuration associated with the first flow;
Determining a time of arrival (ToA) for a PDU associated with a second flow (e.g., ‘flow 2’) such as by using (e.g., starting) a timer and/or based on a time instance when the PDU in the first flow is received;
On condition that a PDU in the second flow is received (e.g., at a time instance) before the primary ETA threshold value (e.g., has elapsed),
   Sending the PDU in the second flow using a default forwarding configuration associated with the second flow;
On condition that a PDU in the second flow is received (e.g., at a time instance) after the primary ETA threshold value and before a secondary ETA threshold value (e.g., has elapsed),
   Determining a (e.g., new) priority for the PDU in second flow where the new priority is higher than the default priority,
   Sending the PDU in the second flow using a suitable (e.g., determined) forwarding configuration matching the determined new priority;
On condition that a PDU in the second flow is received (e.g., at a time instance) after the secondary ETA threshold value (e.g., has lapsed),
   Sending a status indication to the base station (e.g., gNB) which is indicative of late PDU reception (e.g., information indicating the priority of the late PDU and/or the time when the late PDU is received),
   Sending the PDU using a best effort or an available forwarding configuration, such as after receiving an indication from the base station to send the PDU with best effort configuration;
   Dropping (e.g., discarding) the PDU, such as after receiving an indication to drop (e.g., any) late PDU
Sending one or more PDUs in any of the first flow and/or the second flow (e.g., multiple flows) using one or more suitable (e.g., determined) forwarding configurations to satisfy QoS requirements (e.g., joint QoS requirements based on an association between the first flow and the second flow,
Sending information indicating one or more (e.g., determined) forwarding configurations to meet (e.g., ensure) synchronization of data in the first flow and/or the second flow (e.g., multiple flows), such as within a RTT requirement.

In certain representative embodiments, a WTRU may determine a forwarding configuration to use when transmitting data in multiple flows (e.g., in the uplink) to synchronize transmission. The multiple flows may, for example, be synchronized such that a delay between a (e.g., last and/or latest) PDU of an ADU in a first flow and a (e.g., last and/or latest) PDU of an ADU in a second flow is less than or equal to different expected time of arrival (ETA) threshold values (e.g., an inter-flow PDB) For example, the PDUs in the first and second flows may be received from any of an application and/or service (e.g., which generates information in a payload of the PDUs) executed by the WTRU, another WTRU, a base station and/or a network entity.

For example, a WTRU may be configured to perform any of the following:
Receiving information (e.g., configuration information), from a base station (e.g., gNB), indicating first, second and third ETA threshold values (e.g., time instances and/or durations) and one or more forwarding configurations associated with different priorities (e.g., at least one default forwarding configuration (e.g., LCH) per flow for forwarding PDUs in each flow with a default priority value);
Receiving one or more PDUs of an ADU in a first flow and/or sending the PDUs (e.g., of the ADU) using a default forwarding configuration associated with the first flow;
Determining a time of arrival (ToA) for one or more PDUs in a second flow based on a time instance when the first PDU of the ADU in first flow is received;
   Determining the ToA by starting first, second and third timers associated with first, second and third ETA thresholds
On condition that a (e.g., last and/or latest) PDU of an ADU in a first flow and/or one or more PDUs of an ADU in a second flow are received by WTRU before a first ETA threshold value (e.g., has elapsed),
   Sending PDUs of the ADU in the first flow and PDUs of the ADU in the second flow using default forwarding configurations associated with (e.g., any of) the first flow and the second flow;
On condition that (e.g., some or any) PDUs of the ADU in the first flow and/or (e.g., some or any) PDUs of an ADU in the second flow are received after the first ETA threshold value (e.g., has elapsed) and/or before the second ETA threshold value (e.g., has elapsed):
   Determining a (e.g., new) priority for (e.g., late) PDUs of the ADU in the first flow (e.g., the new priority may be higher than the default priority);
   Sending the PDUs of the ADU in the first flow using a related (e.g., suitable) forwarding configuration (e.g., matching the determined new priority);
   Sending the PDUs of the ADU in the second flow using a default forwarding configuration associated with the second flow;
   On condition that a forwarding configuration is unavailable for sending the PDUs of the ADU in the first flow, sending a status indication and/or request indication to the base station (e.g., gNB), and/or
      Sending the PDUs of the ADU in the first flow using a best effort or an available forwarding configuration, such as based on an indication (e.g., to send the PDU with best effort configuration) received from gNB;
On condition that (e.g., some or any) PDUs of the ADU in the second flow are received after the second ETA threshold value (e.g., has elapsed) and/or before the third ETA threshold value (e.g., has elapsed):
   Determining a (e.g., new) priority for (e.g., late) PDUs of the ADU in the second flow (e.g., the new priority may be higher than the default priority);
   Sending the PDUs of the ADU in the second flow using a related forwarding configuration (e.g., matching the determined new priority);
   On condition that a related (e.g., suitable) forwarding configuration is unavailable for sending the PDUs of the ADU in the second flow, sending a status indication and/or request indication to the base station (e.g., gNB), and/or
      Sending PDUs of ADU in second flow using a best effort forwarding configuration (e.g., based on an indication received from the base station);
On condition that (e.g., some or any) PDUs of the ADU in the second flow are received after third ETA threshold value (e.g., has elapsed):
   Sending a status indication and/or request indication to the base station (e.g., gNB) on late PDUs;
   Sending PDUs of the ADU in the second flow using a best effort forwarding configuration and/or dropping PDUs (e.g., based on an indication received from the base station;
Sending one or more PDUs in any of the first flow, the second flow and/or the third flow (e.g., multiple flows) using one or more suitable (e.g., determined) forwarding configurations to satisfy QoS requirements (e.g., joint QoS requirements based on an association between the first flow, the second flow, and/or the third flow; and/or
Sending information indicating one or more (e.g., determined) forwarding configurations to meet (e.g., ensure) synchronization of data in the first flow, the second flow, and/or the third flow (e.g., multiple flows), such as within a RTT requirement.

### Overview

The term eXtended Reality (XR) may be used as an umbrella term for different types of immersive experiences, including any of Virtual Reality (VR), Augmented Reality (AR), Mixed Reality (MR), and/or any realities interpolated among them. For example, Virtual Reality (VR) may refer to a rendered version of a delivered visual and/or audio scene. The rendering may be designed to mimic the visual (e.g. stereoscopic 3D) and/or audio sensory stimuli of the real world (e.g., as naturally as possible) to an observer or user as they move within the limits defined by the application. For example, Augmented Reality (AR) may refer to where a user is provided with additional information and/or artificially generated objects and/or content overlaid upon their current environment. Mixed Reality (MR) ay refer to an advanced form of AR where some virtual elements are inserted into the physical scene (e.g., with the intent) to provide the illusion that these elements are part of the real scene. As used herein, the term XR may include any real and/or virtual combined environments and human-machine interactions generated by computer technology and wearables.

The notion of immersion in the context of XR services may refer to the sense of being surrounded by a virtual environment and/or providing the feeling of being physically and spatially located in a virtual environment. The levels of virtuality may range from partial sensory inputs to fully immersive multi-sensory inputs leading to a virtual reality which may be practically indiscernible from actual reality.

XR devices may be (e.g., typically) associated with capabilities that offer various degrees of spatial tracking. XR devices may be equipped with various sensors to enable spatial tracking, for example monocular, stereo, and/or depth cameras, radio beacons, GPS, inertial sensors, etc. Spatial tracking may be performed at different levels, such as 3 Degrees of Freedom (DoF) (e.g., rotational motion along X, Y and Z axis) or 6 DoF (e.g., rotational and/or translational motion along X, Y and Z axis). For example, spatial tracking may result in an interaction to experience some form of virtual content. The user may act in and/or interact with the components within extended reality. For example, the actions and/or interactions may involve movements, gestures, eye tracking, etc. Spatial tracking may be an enabling feature for immersive XR experience. For example, some form of head and/or motion tracking may ensure that the simulated visual and/or audio components from the user perspective are updated to be consistent with user's movements. Imprecise and/or delayed spatial tracking may lead to sensation of discomfort and/or motion sickness for the user.

As described herein, a WTRU (e.g., user equipment) may correspond to any XR device and/or node, which may come in a variety of form factors. A WTRU (e.g., XR WTRU) may include, but is not limited to, the following: Head Mounted Displays (HMD), optical see-through glasses and camera see-through HMDs for AR and/or MR, mobile devices with positional tracking and/or cameras, wearables, etc. In addition to the above, several different types of XR WTRU may be envisioned based on XR device functions for example as display, camera, sensors, sensor processing, wireless connectivity, XR/Media processing, power supply, etc., to be provided by one or more devices, wearables, actuators, controllers and/or accessories. One or more devices and/or nodes (e.g., WTRUs) may be grouped into a collaborative XR group for supporting XR applications and/or services.

### Traffic Models for XR Applications and Use Cases

In certain representative embodiments, the service and/or traffic flows of (e.g., different) XR applications and/or use cases are identified (e.g., described) in 3GPP TR 26.928.

### Virtual Reality 1 (VR1)

For example, VR1 applications (e.g., streaming of immersive 6DoF) may be modeled using service flows applicable for viewport dependent streaming architecture. Similar to adaptive streaming (e.g., dynamic adaptive streaming over HTTP (DASH)), viewport dependent streaming may allow for dynamically updating the quality of media and/or video based on the available bitrate in the network and/or wireless interface. As per the service and/or traffic flow, tracking and/or pose information (e.g., small packet sizes of <100B) of the XR device's viewport is sent periodically with a relatively low data rate (e.g., 0.5-2 Mbps, 60 to 500 Hz) in the UL to a XR server. In response, the XR server may send in the DL with a relatively high data rate (e.g., 6-18 MBps for 4k omnidirectional and/or FoV area streaming) and may quasi-periodically send (e.g., 40/60/120 fps) the viewport optimized media adaptively (e.g., H.264/265 video), which is then rendered in the XR device display.

For example, traffic characteristics of VR1 may be described as:
UL traffic: Pose and/or viewport information (e.g., including information on 6DoF)
   Small packet size (e.g., relatively constant size<100B), Low data rate (e.g., 0.5-2 Mbps) and/or a single flow,
   Periodic: (e.g., periodicity range of 60 to 500 Hz); and/or
DL traffic: (1) Media and/or Video containing viewport optimized scene (e.g., higher quality) and/or (2) media and/or video for non-viewport scene (e.g., lower quality)
   Large packet size (e.g., variable size with Gaussian distribution or fixed size of 1500B), High data rate (e.g., 6-18 Mbps), E2E latency (e.g., 50 ms), multiple flows (e.g., video flows with different bit-rates, 3D media, metadata),
   Quasi-periodic (e.g., periodicity as a function of frame rate, such as 40/60/120 fps).

### Virtual Reality 2 (VR2)

For example, VR2 applications (e.g., immersive game spectator mode) can be modeled using service flows which are applicable to a split rendering architecture. In such cases, the XR server may perform pre-rendering and/or encoding of the 2D media and/or video frame based on the pose information sent by the XR device periodically at low data rate (e.g., 0.5-2 Mbps, 60-500 Hz). The rendering may (e.g., mainly) performed in the XR-server and sent in the DL at a high data rate and low latency (e.g., 30-45 Mbps, 10-20 ms). The XR device may decompress the received media and/or video and perform asynchronous time-warping (ATW) for correcting the viewport based on the latest pose information. While RTT latency for transmission of pose info in the UL and reception of pre-rendered media in the DL may span up to 50 ms, ATW may satisfy the motion-to-photon latency requirement (e.g., <20 ms) based on in-device processing.

For example, traffic characteristics of VR2 may be described as:
UL: Pose and/or viewport information
   Small packet size (e.g. constant size<100B), Low data rate (e.g., 0.5-2 Mbps), single flow,
   Periodic (e.g., periodicity range of 60 to 500 Hz); and/or
DL: 3D scenes in frame buffers
   Large packet size (e.g., Gaussian distribution, and/or max 1500B, or unlimited), High data rate (e.g., 30-45 Mbps), latency (e.g., RTT of approximately 30 ms and/or max 50 ms), multiple flows (3D video and/or media, metadata),
   Quasi-periodic (e.g., periodicity as a function of frame rate, such as 60/90 fps).

### Augmented Reality 1 (AR1)

For example, AR1 applications (e.g., real-time communication with a shop assistant) may be characterized using service flows applicable to a distributed computing architecture. As per the service and/or traffic flow, the XR device may send pose information (e.g., 0.5-2 Mbps, 60-500 Hz)) and/or video (e.g., 10 Mbps, 10 Hz frame update rate) in the UL to the XR server. The received information may be used by the XR server to generate a scene, which is then converted a 2D (e.g., video) or 3D media (e.g., 3D objects) format along with metadata (e.g., scene description). The compressed media and metadata (e.g., characterized by a Pareto distribution) may be delivered (e.g., quasi-periodically) in the DL at a high data rate (e.g., 30-45 Mbps, 40/60/120 fps). The XR device may then generate an AR scene locally, such by overlaying 3D objects on 2D video, and rendering the scene in the device display.

The traffic characteristics of AR1 are as follows, for example:
UL: Pose information and/or 2D video stream information
   Pose: Small packet size, Low data rate (e.g., 0.5-2 Mbps), Periodic (e.g., 60 to 500 Hz),
   Video: Large packet size, Higher Data rate (e.g., 10 Mbps), Periodic (e.g., update periodicity of 10 Hz), multi-flow video; and/or
DL: 2D and/or 3D pre-rendered media and XR metadata
   Large packet size (e.g., Pareto distribution), High data rate (e.g., 30-45 Mbps), multi-flow (2D and/or 3D media and/or metadata),
   Quasi-periodic (e.g., periodicity as a function of frame rate of 60/90 fps).

### Augmented Reality 2 (AR2)

For example, AR2 applications (e.g., XR meeting, AR animated avatar calls) may use service and/or traffic flows applicable for XR conversational architecture, such as where two or more XR clients and/or device can perform peer-to-peer communications with intermediary media processing in network. Different types of media may be supported for AR2 applications, such as based on the type of user representation including any of 2D+/RGBD (e.g., 2.7 Mbps), 3D mesh (e.g., 30 Mbps), 3D Video point cloud coding (VPCC), and/or Geometry-based point cloud compression (GPCC) (e.g., 5-50 Mbps). In an example XR traffic flow, an XR client in a device initiates a call setup procedure, based on which a session control function may trigger network-based media processing. The SMF may forward the call setup to a second XR client and/or device followed by real-time media processing and streaming with low latency (e.g., E2E<100 ms) to both clients. During an XR call, the 2D and/or 3D media, and possibly the user pose information, may be transmitted quasi-periodically in the UL and DL between the XR clients and/or devices.

For example, the traffic characteristics of AR2 may be described as follows:
UL: 2D and/or 3D media, pose and/or video of user
   Large packet size and/or data rate (e.g., 2.7-50 Mbps), PDB (e.g., <150 ms), multi-flow (2D and/or 3D media),
   Quasi-periodic (e.g, 60 to 500 Hz); and/or
DL: 2D and/or 3D media, pose and/or video of user
   Large packet size (e.g, truncated Gaussian distribution) and/or data rate (e.g., 2.7-50 Mbps), E2E PDB (e.g., <100 ms), multi-flow (2D and/or 3D media),
   Quasi-periodic (e.g, 60 to 500 Hz).

### XR Conferencing

For example, XR conferencing applications may provide an immersive conferencing experience between geographically remote users, such as by representing the users in a 3D volumetric representation (e.g., point clouds and/or meshes). One or more cameras (e.g., with depth perception capability) may be placed at each users' location to allow interactions (e.g., view, hear, rotate, zoom-in, resize, etc.) with a full 3D volumetric representation of one another on their respective headsets and/or glasses. XR conferencing applications may support simultaneous UL and DL media traffic. Media traffic may include any of audio, video and/or 3D objects. The media formats that can be applied to capture the user in 3D volumetric format include any of 2D+/RGBD (e.g., >2.7 Mbps for 1 camera, >5.4 Mbps for 2 cameras), 3D Mesh (e.g., ˜30 Mbps), 3D VPCC and/or GPCC (e.g., 5-50 Mbps). A media processor may be located centrally (e.g., in a core network) or distributed (e.g., in an edge network). Service and/or traffic flow between the XR clients and/or users via the in-network media processor may be expected to be similar to the AR2 and XR conversational use cases. Joining an XR conference session may result in a download peak at the beginning for downloading the virtual environment and associated media objects within the XR application. Throughout the rest of the session, data rates may vary depending on a number of users, upload format of the users, and/or refresh rates of virtual 2D and/or 3D objects and/or environment.

For example, the traffic characteristics of XR Conferencing may be described as follows:
UL: 2D and/or 3D media, pose and/or real-time video of user
   Large packet size and/or data rate (e.g., 2.7-50 Mbps), multi-flow (2D and/or 3D media),
   Quasi-periodic (e.g., 60 to 500 Hz),
   Low encoder PER (e.g., <10⁻³); and/or
DL: 2D and/or 3D media, pose and/or real-time video of user, 2D and/or 3D objects and/or environment (possibly from third party)
   Large packet size and/or Data rate (e.g., 2.7-50 Mbps), E2E PDB (e.g., <100 ms), multi-flow (2D and/or 3D media),
   Quasi-periodic (e.g., 60 to 500 Hz),
   Low encoder PER (e.g., <10⁻³).

### Cloud Gaming (CG)

For example, CG applications (e.g., 5G online gaming) may predominantly rely on an adaptive streaming architecture where the rendered video and/or media in network is streamed to a thin client in the device (e.g. smartphone, tablet). In a typical service and/or traffic flow for CG, the XR device may (e.g., periodically) send pose information (e.g., 100 to 250B) related to a viewport in UL (e.g., 0.1-1 Mbps, 60-500 Hz) to the XR server. The generated viewport-related video and/or media (e.g., 1500B) is encoded and/or compressed (e.g., H.264 and/or H.265 video) and sent quasi-periodically by the XR server in DL (e.g., 30-45 Mbps, 30/50/60/90/120 fps, PER: 10⁻³). The received video and/or media may then be rendered in the XR device upon decoding and processing. The RTT latency for supporting certain high-end CG applications (e.g., Category D of photo-realistic or natural video games) may be determined by the roundtrip interaction delay (e.g., 50 ms). For other CG applications (e.g., Categories A, B and/or C), the UL PDB may be 10 ms and the DL streaming PDB may range from 50 ms to 200 ms.

For example, the traffic characteristics of CG may be described as follows:
UL: Pose and/or viewport information
   Small packet size (e.g., 100 to 250B), Low data rate (e.g., 0.1-1 Mbps), PDB: 10 ms, single flow,
   Periodic (e.g., periodicity range of 60 to 500 Hz); and/or
DL: 2D and/or 3D media and/or video of user
   Large packet size (e.g., max 1500), High data rate (e.g., 30-45 Mbps), PDB: 20 ms, multi-flow (2D and/or 3D media, video)
   Quasi-periodic (e.g., periodicity as a function of frame rate of 30/50/60/90/120 fps),
   PER: 10e-3.

XR applications may be associated with (e.g., generate and/or receive) multiple data flows per application and/or service which may be transmitted independently over the Uu interface. The multiple data flows may originate from different devices (e.g., HMD, smart phone, haptic gloves) associated with a WTRU. For example, a possible use case is a shared XR experience where users, equipped with multiple XR devices, can interact with each other while being physically located at different places (e.g., two people in different locations shaking hands).

For example, each data flow may have different traffic characteristics (e.g., packet sizes and/or arrival distributions). For example, each data flow may have independent and/or different QoS (e.g., packet error rate, delay budget) requirement. A WTRU may be configured to (e.g., attempt) to ensure the QoS requirements for each flow is fulfilled independently. Similarly, traffic prioritization at the scheduler in the network may also be performed for each QoS flow independently. A WTRU may also support other additional applications which may have higher priority values relative to the flows associated with the XR application supported by WTRU.

In addition to the RAN QoS (e.g., PER and/or latency) that each data flow may be required to fulfil (e.g., independently), coordination among the data flows may be needed so that a bound on inter-flow time delay can be guaranteed. For example, even a slight delay and/or lack of synchronization between data flows may lead to poor QoE and/or may lead to acute discomfort or illness (e.g., vomiting, disorientation) to a user.

In this regard, coordination of the multiple data (e.g., QoS) flows of an XR experience, which may originate from different devices, may be important so that the flows are delivered in the UL to the gNB and application server (e.g., an edge server collocated with gNB) within a specified synchronization time window to ensure all flows can be processed and/or rendered jointly. A similar issue may need to be addressed when the flows are delivered in the DL such that the different flows are received at the WTRU from the gNB within a synchronization time window.

### Determining Forwarding Configuration for Ensuring Synchronization of Multiple Data Flows

In certain representative embodiments, a WTRU (e.g, XR WTRU) may perform transmission of PDUs in one or more data flows (e.g., associated with an application). For example, PDUs may be transmitted to ensure the PDUs in different flows are transmitted and/or received for fulfilling one or more joint QoS requirements. As an example, the QoS requirements may be based on any of the following: threshold values, configurations, triggers, conditions and/or criteria received from network and/or application (e.g., an application function hosted by a WTRU). In an example, a WTRU may perform transmission of PDUs in different flows such that the difference in terms of QoS (e.g., latency, data rate, reliability) achievable between the PDUs in different flows are within the QoS requirements associated with the application. In another example, a WTRU may perform transmissions of PDUs, such as in a synchronized manner (e.g., transmitted simultaneously or with minimal reception time difference), such that the flows are received at a receiving entity (e.g., base station, application function, CN function), within a synchronization window.

In certain representative embodiments, a synchronization window may be associated with a synchronization requirement. A synchronization requirement may be dependent on an application supported by a WTRU. For example, an application consisting of two data flows (e.g., video data flow and pose data flow) may prefer (e.g., require) the PDUs in the different data flows to be received at one or more entities and/or functions (e.g., WTRU, gNB, edge server function, remote server function) within a QoS bound (e.g., latency bound), which may correspond to the difference in QoS between the PDUs in the first and second data flows.

A synchronization window may be applicable to any QoS metrics including latency, data rate and/or reliability. In cases where a synchronization window is associated with (e.g., corresponds to) a data rate, the PDUs in one or more associated flows may be considered as synchronized, for example, when the PDUs are transmitted and/or received with the data rate values associated with the individual flows satisfy any of a joint minimum and/or joint maximum data rate values associated with the one or more flows associated with the application are satisfied. In cases where a synchronization window is associated with (e.g., corresponds to) latency, the PDUs in one or more associated flows may be considered as synchronized, for example, when the PDUs are transmitted and/or received with the latency bounds (e.g., PDB) associated with the individual flows satisfy any of a joint minimum and/or joint maximum latency bounds associated with the one or more flows belonging to the application.

In certain representative embodiments, the PDUs in the different data flows may be received at a WTRU from other devices (e.g., associated with the WTRU) and/or from other functions and/or entities (e.g., co-located with the WTRU) (e.g. higher layer, application layer functions). For example, where the PDUs in the different associated flows are handled and/or forwarded independent of each other during forwarding and/or transmission, a drift condition may be introduced, such that the PDUs in the different associated data flows may drift from one another (e.g., reception time drift). This drift may result in the PDUs in different data flows being caused to arrive at a receiving entity (e.g., gNB) beyond the synchronization window required by the application.

In certain representative embodiments, a network may include any of a base station (e.g., gNB, TRP, RAN node), a core network function and/or an application function (e.g., edge server function, remote server function). In certain representative embodiments, flows may correspond to any of: QoS flows and/or data flows (e.g., flow of data or PDUs) which may be associated with one or more QoS requirements, such as latency, data rate, and/or reliability. In certain representative embodiments, a forwarding configuration may be associated with (e.g., correspond to) any of: one or more radio bearers, one or more logical channels, one or more configuration parameters in the individual layers within the access stratum protocol stack (e.g., SDAP, PDCP, RLC, MAC, and/or PHY), one or more parameters associated with logical channel prioritization (LCP) (e.g., priority, PBR, and/or BSD), parameters associated with mapping from data and/or QoS flows to radio bearers (e.g., parameters at SDAP), one or more carriers, one or more BWPs, and one or more links (e.g., used for delivering the PDUs in UL direction or DL direction).

Determination of Association Between Data Flows based on Configured Parameters and/or Identifiers

In certain representative embodiments, a WTRU (e.g., XR WTRU) may determine whether one or more data flows received and/or transmitted by the WTRU are associated with an application and/or service based on explicit and/or implicit parameters and/or identifiers detectable by the WTRU in the data flows. For example, the parameters and/or identifiers for determining the association between flows may be configured in the WTRU (e.g., via RRC signaling, NAS-layer signalizing, and/or application layer signaling).

As examples, the parameters and/or identifiers used by the WTRU for identifying the association between plural data flows (e.g., first, second, or more flows) may include any of (e.g., a combination of any of) the following:
Identifiers and/or IDs associated with flows and/or application
   For example, a WTRU may determine a first flow and a second flow may be associated with an application, such as where the WTRU may detect a common ID associated with the application within the PDUs (e.g., in a header and/or payload of a data unit) of the first flow and/or the second flow. The ID of the application may be preconfigured in the WTRU, for example.
Priority and/or importance info associated with flows
   For example, a WTRU may determine a first flow and a second flow may be associated with an application, such as by detecting common and/or similar priority and/or importance indications in the PDUs (e.g., in header and/or payload) of first flow and second flow.
   For example, a WTRU may determine a first flow and a second flow may be associated, such as when the priority and/or importance indications detected by WTRU (e.g., in a header or payload of a data unit) may be above and/or below one or more priority and/or importance threshold values.
Temporal and/or timing information in associated flows
   For example, a WTRU may determine a first flow and a second flow may be associated, such as where one or more PDUs in a first flow and one or more PDUs in a second flow may be received by the WTRU within a time duration and/or window. For example, the time duration/window may correspond to a time difference between a reception time of a PDU in first flow (e.g., at ‘t1’) and the reception time of a PDU in second flow (e.g., at ‘t2’). For example, the WTRU may determine the first and second flows may be associated when a time difference (e.g., t2−t1) satisfies (e.g., is less than) a time duration and/or window threshold value.
   For example, a WTRU may determine the first and second flows may be associated based on a common format and/or granularity of the timing information (e.g., timestamps) carried in (e.g., the PDUs associated with) the first and second flows.
Spatial and/or pose information in associated flows
   For example, a WTRU may determine a first flow and a second flow may be associated, such as when the PDUs carrying the spatial information correspond to common spatial parameters. The spatial parameters, for example, may include any of the following: direction and/or orientation of FoV of the devices, slice and/or tile of the video and/or media frame, location info (e.g., coordinates), pose info, etc. The spatial parameters may be determined by WTRU based on detection on certain PDUs transporting spatial information (e.g., pose and/or control PDUs which may be identified by WTRU based on data type identifiers) and/or detection of other PDUs which may contain spatial information within the PDUs (e.g., in header and/or payload), for example.
      Sending Assistance Information to Network on Application Parameters and/or Requirements

In certain representative embodiments, a WTRU (e.g., XR WTRU) may send information associated with an application supported in WTRU to the network, such as for supporting an application awareness feature in the network. For example, information regarding the application may be sent to the network as assistance information, status information and/or indications thereof.

For example, the information associated with the application, which may be sent by the WTRU to the network, may include any of (e.g., a combination of any of) the following:
Applications supported by WTRU
   For example, a WTRU may send a number and/or IDs associated with the applications supported. The WTRU may (e.g., also) send information on the relative and/or absolute priority values associated with the supported applications.
Data flows associated with the application
   For example, a WTRU may send the number and/or IDs associated with the data flows supported per-application. The WTRU may (e.g., also) send information on the relative and/or absolute priority values associated with the data flows.
Devices associated with the application
   For example, a WTRU may send a number and/or IDs associated with the devices supported and/or the association of the devices per-application.
Data and/or Traffic types associated with the data flows per-application
   For example, a WTRU may send information on a data type in the first and second flows associated with an application, such as where the data type may include any of video data (e.g., I-frame data, P-frame data, B-frame data), RGB-D data, 360 degrees video data, haptics data, pose and/or positioning data, audio data, etc.
Characteristics and/or parameters of data and/or traffic associated with the data flows per-application
   For example, a WTRU may send information on characteristics of the first and second flows associated with an application, such as including whether the data is periodic, aperiodic, semi-persistent, quasi-periodic, etc.
   For example, a WTRU may send information on a number of PDUs expected (e.g., per ADU) in one or more flows per-application. The information on number of PDUs (e.g., per ADU) may (e.g., also) include statistical information including any of mean, min, max, and/or standard deviation values.
   For example, a WTRU may send QoS requirements of the one or more flows associated with application, such as including any of data rate, latency (e.g., PDB), reliability (e.g., PER), absolute and/or relative priority values, etc.

For example, a WTRU may send to the network information associated with multiple data flows associated with an application and/or service based on any of (e.g., a combination of any of) the following:
During connectivity and/or session establishment and/or (re)configuration (e.g., procedures)
   For example, during any of an RRC connection, a PDU session, an application session establishment, and/or a (re)configuration procedure.
When changing and/or updating data flows per application
   For example, when adding new flows and/or releasing existing flows associated with an application.
When receiving higher layer and/or application information
   For example, when receiving an indication (e.g., from an application function hosted in the WTRU and/or in the network) indicating any of change in data types supported, traffic characteristics, and/or QoS requirements, etc.
When detecting change in measurements and movements
   For example, when any of RSRP, RSRQ, RSSI measurements of any of signals, channels, radio links, carriers, etc., (which may be associated with the one or more data flows) are above and/or below threshold values.
   For example, when pose and/or positioning measurements (e.g., location information and/or pose in 6DoF) are above and/or below pose threshold values.
When detecting change in time and/or timing attributes
   For example, a WTRU may send information periodically or when a time period (e.g., a timer) associated with the sending of assistance information is set and/or elapses (e.g., expires).

For example, a WTRU may send to the network the information associated with multiple data flows associated with an application and/or service, such as assistance information, via AS layer signaling (e.g., any of RRC signaling and/or messages, MAC CE and/or DCI) or Non-AS (NAS) layer signaling (e.g., PDU session related messages).

### Receiving Configuration Information for Ensuring Synchronized Transmission of Multiple Flows

In certain representative embodiments, a WTRU (e.g., XR WTRU) may perform transmission of PDUs in one or more (e.g., associated) data flows, such as based on one or more parameters, threshold values, and/or triggering conditions, which may be received by the WTRU from the network as configuration information.

For example, the configuration information received by the WTRU may include any of (e.g., a combination of any of) the following parameters:
Expected time of arrival (ETA) threshold values
   For example, a WTRU may receive one of more ETA threshold values associated with (e.g., corresponding to) an expected time for receiving a PDU in a data flow, such as where the PDU may be the first PDU or any subsequent PDUs after receiving a prior PDU (e.g., first PDU).
   For example, an ETA threshold value may be associated with an expected time for receiving a first PDU in a second data flow after receiving a first PDU in a first data flow, such as where the first and second data flows are associated with an application. In an example, an ETA threshold value may be associated with a time duration or time value. A WTRU may start a timer at a time instance when receiving a first PDU in the first flow and stop the timer when the timer expires at the time instance corresponding to the ETA threshold value and/or when receiving a first PDU in the second flow (e.g. first and second flows are associated with same application). The WTRU may determine an elapsed time between receiving a (e.g., first) PDU in the first flow and receiving a (e.g., first) PDU in the first flow.
Expected data rate (EDR) threshold values
   For example, a WTRU may receive one or more expected data rate threshold (EDR) values associated with a data rate expected for receiving a PDU in a data flow (e.g., a first PDU or subsequent PDU after receiving the prior PDUs). The data rate may correspond to any of the following units: PDUs per second, frames per second, and/or bits per second, etc. In another example, the EDR threshold values may be associated with a data rate expected for the PDUs in the second associated data flow after receiving the PDUs in a first data flow with a first data rate value.
Expected reliability threshold values
   For example, a WTRU may receive one or more expected reliability threshold (EER) values associated with a reliability expected for receiving a PDU in a data flow (e.g., a first PDU or subsequent PDU after receiving the prior PDUs). The reliability values may correspond to any of the following units: packet error rate, frame error rate, and/or probability of error, etc. In another example, the EER threshold values may be associated with a reliability expected for the one or more PDUs in the second associated data flow after receiving one or more PDUs in a first data flow with a first reliability value.
Forwarding configuration parameters
   For example, as part of a forwarding configuration, a WTRU may receive one or more default and/or reference priority values associated with (e.g., corresponding to) the flow channels (e.g., radio bearer and/or LCH) associated with an application. For example, a first flow channel may be associated with a first priority value and/or a second flow channel may correspond to a second priority value. The first and second flow channels may be associated with the same application and the first and second default priority values may be intended to achieve a default QoS performance (e.g., default latency and/or default data rate) for the PDUs in the first and second flow channels during transmission, for example.
   For example, a WTRU may (e.g., also) receive a set of one or more alternative configurations (e.g., non-default configurations), including alternative parameters and/or threshold values which may be used by WTRU when performing data transmissions, for example. In an example, the alternative configurations may include one or more priority values associated with the flow channels, which the WTRU may be allowed to use when performing data transmissions. For example, the WTRU may be allowed to use an alternative configuration consisting of a first and/or second priority values when using a first LCH associated with a first data flow and/or may be allowed to use an alternative configuration consisting of a third and/or fourth priority values when using a second LCH associated with a second data flow (e.g., first and second data flows are associated with an application).
   For example, a WTRU may (e.g., also) receive criteria indicating when and/or how the WTRU may use a default and/or alternative configurations. For example, the criteria may indicate using the default configuration when the PDUs in the first and/or second data flows are received within a first expected threshold (e.g., ETA threshold) and/or using an alternative configuration when the PDUs in the first and/or second data flow are received after the first expected threshold (e.g., ETA threshold).

For example, a WTRU may receive the configuration information (e.g., default and/or alternative configurations) associated with performing transmission of PDUs in different associated data flows, via AS layer signaling (e.g., any of RRC signaling and/or messages, MAC CE and/or DCI) or Non-AS (NAS) layer signaling (e.g., PDU session related messages).

Transmission of PDUs in Different Associated flows Within Synchronization Time Window

In certain representative embodiments, a WTRU may perform transmission of PDUs in different data flows associated with an application and/or service based on one or more ETA threshold values and/or information on how the PDUs in different flows (e.g., using flow IDs) may be associated between one another, such that the PDUs may be sent and/or received within a synchronization time window.

For example, a WTRU may receive configuration information from the network including any of (e.g., a combination of any of) the following parameters:
First expected time of arrival (ETA) threshold value
   For example, a first ETA threshold may be associated with a first time duration (e.g., a normal or default time duration) expected for receiving one or more PDUs in the first flow and/or second flow.
Second expected time of arrival (ETA) threshold value
   For example, a second ETA threshold may be associated with a second time duration (e.g., beyond and/or greater than a normal time duration, such as used for expediting delayed PDUs) expected for receiving one of more PDUs in the first flow and/or second flow.
One or more forwarding configurations (e.g., LCHs and/or radio bearers) with different priority values, such as where at least one forwarding configuration may be associated with a first data flow and a second forwarding configuration may be associated with a second data flow, where the first and second data flows may be associated to the same application and/or service.
   For example, the first and/or second forwarding configurations may be associated with default priority values and/or alternative priority values.
Identifiers and other parameters (e.g., timestamps and/or sequence numbers) to be detected in the PDUs in first flow and second flow
   For example, the PDUs in first and second flow may carry (e.g., in packet headers) the same or similar identifiers and/or IDs when the flows are associated with the same application and/or service.
   For example, a WTRU may use timestamp information and/or sequence numbers (e.g., in packet headers) for determining timing information associated with the PDUs (e.g., time of arrival, time of packet creation, time of departure, and/or remaining time for sending the PDUs).

In certain representative embodiments, after receiving configuration information, a WTRU (e.g., XR WTRU) may receive a first PDU in a first data flow from an associated device and/or function (e.g., via sidelink and/or via a function and/or entity co-collocated with the WTRU). For example, the WTRU may identify that the first PDU in the first flow may belong to an application and/or service (e.g., XR application) supported by the WTRU based on the identifiers and/or IDs detectable in the PDU header. For example, the first PDU may be received by the WTRU at the SDAP layer or at the buffer associated with the first LCH. As an example, the WTRU may send the first PDU in the first data flow (e.g., via a first LCH) using the default forwarding configuration (e.g., a default priority value associated with the first LCH), such as when sending the PDU in the UL to a gNB.

In certain representative embodiments, a WTRU may start a first timer after receiving the first PDU in the first data flow. For example, the first timer may run for a duration (e.g., spanning) up to the first ETA threshold value. In certain representative embodiments, a WTRU may start a second timer after receiving the first PDU in the first data flow. For example, the second timer may run for a duration (e.g., spanning) up to the second ETA threshold value. In an example, the WTRU may start the first and second timers at a same time and the WTRU may let the timers run for a duration up to their respective ETA threshold values. In another example, the WTRU may start and/or stop the timers sequentially. The second timer may be started after the expiry of the first timer (e.g., of the first ETA threshold value) and/or or the second timer may be let to run for a duration up to the second ETA threshold.

In certain representative embodiments, a WTRU may (e.g., be configured with) a first time duration associated with receiving the first PDU in the first data flow. For example, the first time duration may correspond to the first ETA threshold value. In certain representative embodiments, a WTRU may (e.g., be configured with) a second time duration associated with receiving the first PDU in the first data flow. For example, the second timer may correspond to the second ETA threshold value. In an example, the WTRU may determine a start of the first and second time durations at a same time and the WTRU may determine whether the first time duration and/or the second time duration have elapsed. In another example, the WTRU may determine a start of the first and second time durations sequentially and/or the WTRU may determine whether the first time duration and/or the second time duration have elapsed sequentially. The second time duration may start after the first time duration has elapsed (e.g., elapsing of the first ETA threshold value) and/or or the second time duration may be determined to elapse using the second ETA threshold value. The first time duration may be determined to elapse using the first ETA threshold value.

In certain representative embodiments, the WTRU, depending on when the first PDU in the second data flow (e.g., associated with the first PDU in the first data flow) may be received by the WTRU, may take any (e.g., any combination of) the following actions:
For example, when the first PDU in the second flow is received by WTRU before the first ETA threshold value (e.g., before expiry of first timer or elapsing of the first ETA threshold value), the WTRU may:
   Send the first PDU in the second flow using the default forwarding configuration associated with second flow (e.g., using a default priority value associated with a second LCH), such as when sending the PDU in the UL to a gNB.
For example, when the first PDU in the second flow is received by WTRU after the first ETA threshold value (e.g., after expiry of the first timer or elapsing of the first ETA threshold value) and/or before the end of second ETA threshold value (e.g. before expiry of second timer or before elapsing of the second ETA threshold value), the WTRU may perform one or more of the following:
   Determine a priority to be assigned to the first PDU of the second flow based on the time instance when the first PDU of first flow is received, the time instance when the first PDU of second flow is received and the first ETA threshold value. For example, the WTRU may determine the time instances when the first PDU in first and/or second flows are received based on the timestamp information.
   Determine the priority to be assigned to the first PDU of second flow based on the reception time of the PDU in first flow (e.g., at ‘t1’), and a reception time of the PDU of second flow (e.g. at ‘t2’). For example, the priority may be assigned such that the time difference between PDUs in first and second flows is less than or equal to the first ETA threshold value.
   Determine the time difference between the reception of the first PDU of first flow and first PDU of second flow. The WTRU may use a higher priority to the delayed PDUs (e.g., PDUs received after a ETA threshold value has elapsed) by determining a compensation latency value that may allow the delayed PDUs to be sent in the UL faster than using the default priority value.
   Determine (e.g., calculate) the compensation latency value by subtracting the first ETA threshold value from the time difference (e.g., t2−t1−first ETA threshold). For example, the priority to be assigned to the PDU may be determined based on a mapping relation between the calculated compensation latency value and the priority to be assigned. For example, the mapping relation between the compensation latency and the priority may be received by the WTRU as (e.g., part of) configuration information.
   For example, the WTRU may be preconfigured with one or more forwarding configurations which may be associated with different priority values, and/or with at least a forwarding configuration with a priority value matching the determined priority value for compensating the latency for the PDU in second flow. A forwarding configuration may be selected with a matching priority value. For example, the WTRU may send the first PDU in the second flow in UL to gNB using the selected forwarding configuration.
   For example, the WTRU may not be configured with and/or be able to determine at least an active forwarding configuration (e.g., preconfigured and/or activated) which may be associated with a priority value matching the determined priority value for compensating the latency for the PDU in second flow or a forwarding configuration with matching priority may be determined to be not available (e.g. due to higher load conditions where the number of PDUs buffered in the forwarding configuration or LCH is greater than a threshold), the WTRU may send an indication to the network to request to configure and/or activate a forwarding configuration with the determined priority value. For example, the WTRU may send in the indication of the determined priority value to be assigned to the forwarding configuration.
   After receiving an indication from the network indicating the configuration and/or activation of a selected forwarding configuration, the WTRU may send the first PDU in the second flow using the configured and/or activated forwarding configuration, such as when sending the PDU in the UL.
For example, when the first PDU in the second flow is received by the WTRU after the second ETA threshold value (e.g., after expiry of second timer or elapsing of the second ETA threshold value), the WTRU may perform one or more of the following:
   Send an indication to gNB (e.g. in AS-layer signaling, MAC CE, UCI), indicating the reception of PDU in second flow after the second ETA threshold (e.g. reception time exceeded the second timer), for example.
   After receiving an indication (e.g., from a gNB) to send the PDU in second flow using an available and/or activated forwarding configuration (e.g., LCH) with an indicated priority value, send the first PDU in the second flow using the forwarding configuration with the indicated priority value, such as when sending the PDU in the UL.
   After receiving an indication (e.g., from a gNB) to send the PDU in second flow using a best effort forwarding configuration (e.g., LCH), the WTRU may send the first PDU in the second flow using an available forwarding configuration with the highest priority value and/or with a best effort priority value, such as when sending the PDU in the UL.
   After receiving an indication (e.g., from a gNB) to drop the PDU in second flow, drop the PDU and/or may not send the PDU in the UL.

### Transmission of a Group of Associated PDUs in Different Associated Flows Within Synchronization Time Window

In certain representative embodiments, a WTRU may perform transmission of one or more associated PDUs (e.g., associated with ADUs) in different associated data flows based on configuration information, association information of ADUs in different flows and/or monitoring of the reception time (e.g., time instance of arrival) of the PDUs. For example, when transmitting PDUs in first and second flows which may be associated to an application and/or service, the WTRU may ensure that a transmission time difference for transmitting a last PDU associated with the ADU in the first flow and a last PDU associated with the ADU in the second flow is less than or equal to a synchronization time window (e.g., inter-flow latency bound). For example, the synchronization time window may be associated with the application and/or service.

In certain representative embodiments, the WTRU may receive configuration information from the network and the configuration information may include any (e.g., any combination) of the following:
First expected time of arrival (ETA) threshold value
   For example, the first ETA threshold may be associated with a first time duration (e.g., a normal or default time duration) expected for receiving one of more PDUs (e.g., associated with one or more ADUs) in the first and second flows.
Second expected time of arrival (ETA) threshold value
   For example, the second ETA threshold may be associated with a second time duration (e.g., beyond and/or greater than normal time duration, such as for expediting delayed PDUs) expected for receiving one of more PDUs (e.g., associated with one or more ADUs) in the first flow.
   For example, the second ETA threshold may be associated with a first time duration (e.g., normal or default time duration) expected for receiving one or more PDUs (e.g., associated with one or more ADUs) in the second flow.
   For example, the second ETA threshold may be used for determining whether to send the PDUs in the first and second flows using a normal and/or default forwarding configuration and/or an alternative forwarding configuration (e.g., for expedited transmission and/or delivery).
Third expected time of arrival (ETA) threshold value
   For example, the third ETA threshold may be associated with a second and/or third time duration (e.g. beyond and/or greater than a normal time duration, such as for expediting delayed PDUs and/or deciding whether to drop PDUs or send PDUs with a best effort configuration) expected for receiving one of more PDUs (e.g., associated with one or more ADUs) in the first flow and/or second flow.
Number of PDUs per ADU expected in the first flow and second flow
   For example, first and second flows may be associated with an application and/or service.
   For example, the first flow may have N PDUs per ADU and the second flow have M PDUs per ADU (e.g., where N and M may be different integer values).
One or more forwarding configurations (e.g., LCHs and/or radio bearers) with different priority values
   For example, at least one forwarding configuration may be associated with a first data flow and a second forwarding configuration may be associated with a second data flow. For example, the first and second forwarding configurations may be associated with default priority values and/or alternative priority values.
Identifiers and/or other parameters to be detected in the PDUs in first flow and second flow
   For example, information indicating timestamps and/or sequence numbers may be detected in the PDUs.
   For example, the PDUs in first and second flow may carry (e.g., in packet headers) a same or similar identifiers and/or IDs, such as when the flows are associated with the same application and/or service.
   For example, the PDUs in first and second flow may carry (e.g., in packet headers) identifiers and/or IDs indicating an association with an ADU in the respective flows. As an example, the one or more PDUs associated with an ADU may carry info related to the ADU (e.g., ADU ID and/or data type of ADU).
   For example, the WTRU may use timestamp information (e.g., in packet headers) for determining the timing information associated with the PDUs and/or ADUs (e.g., time of arrival, time of packet creation, time of departure and/or remaining time for sending the PDUs).
   For example, the WTRU may use the sequence numbers (e.g., in packet and/or PDU headers) and/or ADU information (e.g., ADU ID) for determining whether the PDU is the first, second, or Nth PDU associated with the ADU.

In certain representative embodiments, after receiving the configuration info, the WTRU may receive the one or more PDUs associated with an ADU in the first data flow from an associated device and/or function. For example, the WTRU may identify that the one or more PDUs in first flow may belong to an application and/or service (e.g., XR application) supported by WTRU and/or an ADU based on the identifiers and/or IDs and/or sequence numbers detectable in the PDU header. A first PDU may be received by the WTRU at the SDAP layer or at a buffer associated with the first LCH, for example. The WTRU may send the one or more PDUs in the first data flow (e.g., first LCH) using a default forwarding configuration (e.g., default priority value associated with first LCH), such as when sending the PDU in the UL to a gNB.

In certain representative embodiments, a WTRU may start a first timer after receiving the first PDU associated with an ADU in the first data flow. For example, the timer may run for a duration spanning up to the first ETA threshold value. The WTRU may determine the number of PDUs associated with the ADU in the first flow (e.g., based on the sequence numbers in the PDUs), that may be received prior to the end of the first ETA threshold (e.g., before expiry of first timer). The WTRU may (e.g., also) determine the number of PDUs, associated with another ADU, received in the second flow before the end of the first ETA threshold.

In certain representative embodiments, a WTRU may associate a first time duration with the reception of the first PDU associated with an ADU in the first data flow. For example, the first time duration may correspond to or may be based on the first ETA threshold value. The WTRU may determine the number of PDUs associated with the ADU in the first flow (e.g., based on the sequence numbers in the PDUs), that may be received prior to (e.g., upon) a elapse of the first time duration. The WTRU may (e.g., also) determine the number of PDUs, associated with another ADU, received in the second flow prior to (e.g., upon) a elapse of the first time duration.

In certain representative embodiments, a WTRU may start a second timer and/or a third timer after receiving the first PDU in the first data flow. For example, the second and/or third timers may run for a duration spanning up to the second ETA threshold value and/or third ETA threshold value (e.g., respectively). In an example, the WTRU may start the first, second and third timers at the same time and the WTRU may let the timers to run for a duration up to their respective ETA threshold values. In another example, the WTRU may start the timers sequentially, where the second timer may be started after the expiry of the first timer (e.g., at the first ETA threshold value) and/or the third timer may be started after the expiry of the second timer (e.g., at the second ETA threshold value). For example, the WTRU may let the second timer and/or third timer to run for a duration up to their respective ETA threshold values (e.g. second and third threshold values).

In certain representative embodiments, a WTRU may associate a second timer and/or a third timer with the reception of the first PDU in the first data flow. For example, the second time duration may correspond to or may be based on the second ETA threshold value. For example, the third time duration may correspond to or may be based on the third ETA threshold value. In an example, the first, second and/or third time durations may correspond to a same start time. Each of the first, second, and/or third time durations may be determined according to their respective ETA threshold values. In another example, the first, second and/or third time durations may be set sequentially, such as where the second time duration may be started after the elapse of the first time duration (e.g., after the first ETA threshold time from a reference time or PDU reception time) and/or the third time duration may be started after the elapse of the second time duration (e.g., after the second ETA threshold time from a reference time or PDU reception time). For example, the WTRU may determine the second and/or third time durations using the second and/or third ETA threshold values.

In certain representative embodiments, a WTRU (e.g., XR WTRU), depending on when the PDUs associated with the ADU in the first data flow and/or the PDUs associated with the ADU in the second data flow are received, may perform any (e.g., any combination) of the following actions:
For example, when the last PDU associated with the ADU in the first flow and/or the one or more PDUs associated with the ADU in the second flow are received (e.g., by the WTRU) before the first ETA threshold value (e.g., before expiry of first timer or before a first time duration has elapsed):
   Send the last PDU associated with the ADU in the first flow and/or the one or more PDUs associated with the ADU in the second flow using respective default forwarding configurations associated with the first flow and/or the second flow (e.g., using a default priority value associated with first and/or second LCHs), such as when sending the PDUs in the UL to a gNB.
For example, when one or more PDU associated with the ADU in the first flow and/or one or more PDUs associated with the ADU in the second flow are received (e.g., by the WTRU) after the first ETA threshold value (e.g., after expiry of first timer or after a first time duration has elapsed) and/or before the end of second ETA threshold value (e.g. before expiry of second timer or before a second time duration has elapsed):
   Determine a priority to be assigned to the one or more PDUs (e.g., including last PDU) associated with the ADU in the first flow based on the time instance when the different (e.g., batches of) PDUs of first the flow are received. For example, the different PDUs of the first flow may include batches of PDUs received before and after the first ETA threshold value (e.g., the first time duration has elapsed). For example, the WTRU may determine the time instances when the PDUs in first flow are received based on the timestamp information.
   Determine a priority to be assigned to the one or more PDUs of the first flow (e.g., including the last) received after the first ETA threshold based on the reception time of the PDUs in a first batch in the first flow (e.g., the PDUs received before a time duration associated with the first ETA threshold has elapsed), and reception time of the PDUs in a second batch in the first flow (e.g., the PDUs received after a time duration associated with first ETA threshold has elapsed). For example, a priority may be determined and/or assigned such that a time difference between a last PDU in the first batch (e.g., at ‘t1’) and a last PDU in the second batch (e.g., at ‘t2’) in the first flow is less than or equal to the first ETA threshold value. For example, the WTRU may use a higher priority for any delayed PDUs (e.g., PDUs received after a time duration associated with an ETA threshold value has elapsed) by determining a compensation latency value that may allow the delayed PDUs to be sent in the UL faster than using the default priority value.
   Calculate a compensation latency value, such as by subtracting the first ETA threshold value from the time difference (e.g., t2−t1−first ETA threshold). For example, the priority to be assigned to the PDUs in the second batch may be determined based on a mapping relation between the calculated compensation latency value and the priority to be assigned. For example, the mapping relation between the compensation latency and the priority may be received by the WTRU as (e.g., part of) configuration information.
   Send the one or more PDUs associated with the ADU in the second flow using the default forwarding configurations associated with the second flow (e.g., using a default priority value associated with a second LCH), such as when sending the PDUs in the UL to a gNB.
   In cases where the WTRU is be preconfigured with one or more forwarding configurations which may be associated with different priority values, and/or with at least a forwarding configuration with a priority value matching the determined priority value for compensating the latency for the PDU in second batch in first flow, select the forwarding configuration with matching priority value. For example, the WTRU may send the PDUs (e.g., in a second batch) in the first flow in the UL to a gNB using the selected forwarding configuration.
   In cases where the WTRU may not find and/or determine at least an active forwarding configuration (e.g., preconfigured and/or activated) which may be associated with a priority value matching the determined priority value for compensating the latency for the PDUs in a second batch in the first flow or a forwarding configuration with a matching priority may be determined to be not available, send an indication to the network to request to configure and/or activate a forwarding configuration with the determined priority value. For example, the WTRU may send the determined priority value to be assigned to the forwarding configuration in the indication.
   After receiving information from the network indicating the configuration and/or activation of a selected forwarding configuration, send the PDUs in the second batch in the first flow using the configured/activated forwarding configuration, such as when sending the PDU in the UL to a gNB.
For example, when the one or more PDUs associated with the ADU in the second flow are received by the WTRU after the second ETA threshold value (e.g. after expiry of second timer or after the second time duration has elapsed) and/or before the end of third ETA threshold value (e.g., before expiry of a third timer or before a third time duration has elapsed):
   Determine a priority to be assigned to the one or more PDUs (e.g., including a last PDU) associated with the ADU in the second flow based on the time instances when the different batches of PDUs of the second flow are received. For example, the different batches may be received before and after the first and/or second ETA threshold values (e.g., time durations have elapsed). For example, the WTRU may determine the time instances when the PDUs in the second flow are received based on the timestamp information.
   Determine the priority to be assigned to the one or more PDUs of second flow (e.g., including a last PDU) received after the second ETA threshold (e.g., second time duration has elapsed) based on the reception time of the PDUs in the first batch in the second flow (e.g., the PDUs received before the first and/or second ETA threshold values or before first and/or second time durations have elapsed) and based on the reception time of the PDUs in the second batch (e.g., PDUs received after second ETA threshold value or after the second duration has elapsed) in the second flow. For example, the priority may be determined such that a time difference between a last PDU in the first batch (e.g. at ‘t1’) and a last PDU in the second batch (e.g., at ‘t2’) in the second flow is less than or equal to the second ETA threshold value.
   Calculate a compensation latency value, such as by subtracting the first ETA threshold value from the time difference (e.g., t2−t1−first ETA threshold). For example, the WTRU may determine the priority to be assigned to the PDUs in the second batch based on a mapping relation between the calculated compensation latency value and the priority to be assigned.
   In cases where the WTRU may be preconfigured with one or more forwarding configurations which may be associated with different priority values and/or with at least a forwarding configuration with a priority value matching the determined priority value for compensating the latency for the PDUs in the second batch in the second flow, select the forwarding configuration with matching priority value. For example, the WTRU may send the PDUs in the second batch in the second flow using the selected forwarding configuration, such as in the UL to a gNB.
   In cases where the WTRU may not find and/or determine at least an active forwarding configuration (e.g., preconfigured and/or activated) which may be associated with a priority value matching the determined priority value for compensating the latency for the PDUs in the second batch in the second flow or a forwarding configuration with a matching priority may be determined to be not available, send information to the network indicating to request to configure and/or activate a forwarding configuration with the determined priority value. For example, the WTRU may send in the indication the determined priority value to be assigned to the forwarding configuration, for example.
   After receiving an indication from the network indicating the configuration and/or activation of a selected forwarding configuration, send the PDUs in the second batch in the second flow using the configured and/or activated forwarding configuration, such as when sending the PDUs in the UL.
When the one or more PDUs in the first flow are received by the WTRU after the second ETA threshold value (e.g., after expiry of second timer or after the second time duration has elapsed) and/or the one or more PDUs in the second flow are received by the WTRU after the third ETA threshold value (e.g., after expiry of the third timer or after the third time duration has expired:
   Send information to a gNB (e.g., in AS-layer signaling, MAC CE, and/or UCI) indicating the reception of PDUs in the first flow and/or the second flow after the second and/or third ETA threshold (e.g., reception times exceeded the second and/or third timers or reception times are after the second and/or third time durations have elapsed).
   In cases where an indication, is received (e.g., from a gNB), indicating to send the PDUs in the first and/or second flow using an available and/or activated forwarding configuration (e.g., LCH) with an indicated priority value, send the PDUs in the first flow and/or second flow using the forwarding configurations with the respective indicated priority values, such as when sending the PDUs in the UL.
   In cases where an indication, is received (e.g., from a gNB), indicating to send the PDUs in the first flow and/or second flow using a best effort forwarding configuration (e.g., LCH), the WTRU may send the PDU in the first flow and/or second flow using an available forwarding configuration with the highest priority value and/or with best effort priority value when sending the PDUs in UL.
   In cases where an indication, is received (e.g., from a gNB), indicating to drop the PDUs in the first flow and/or second flow, drop the PDUs and/or not send the PDUs, such as in the UL to a gNB.

### Meeting QoS Requirements Based on Association Between Multiple Flows

In certain representative embodiments, a WTRU may determine one or more actions to perform regarding multiple data flows (e.g., first and second flows. For example, upon determining an association between one of more UL and/or DL data flows (e.g., based on indications related to traffic characteristics that may be configured and/or detected by the WTRU), the WTRU may perform one or more actions to meet QoS requirements (e.g., associated with the UL and/or DL data flows).

For example, a WTRU may determine an association for (e.g., enabling) one or more PDUs (e.g., a PDU set and/or ADU) from different data flows to be forwarded and/or delivered (e.g., in a coordinated manner). One or more (e.g., joint) QoS requirements, such as any of a synchronization time window, latency, and/or data rate, may be common and applicable to one or more associated flows (e.g., among the different data flows) may be met. In an example, any of the actions performed by the WTRU based on the determined association between the multiple flows may correspond to ensuring synchronization of data in the data flows during transmission and/or reception. For example, any of the actions that may be performed by the WTUR may include any of selecting and/or changing the resource (e.g., forwarding) configurations used for forwarding and/or delivering the data in the different data flows, selecting and/or changing the forwarding configuration parameters used for forwarding and/or delivering the data in the different data flows, and/or sending information indicating the selected and/or changed forwarding configurations and/or forwarding configuration parameters (e.g., to a network and/or a higher layer).

In certain representative embodiments, an association between different data flows may be detected by a WTRU. The WTRU may detect an association between different data flows at different layers, such as an application layer, a NAS layer, and/or at any of the access stratum layers (e.g., radio bearers, SDAP, PDCP, MAC, PHY). For example, when an association between the flows is detected at a SDAP layer (e.g., based on reception of an indication from higher layers/application indicating common IDs in the PDUs of two flows), a WTRU may perform certain actions for forwarding the PDUs in a second flow (e.g., by selecting a set of parameters configured at a MAC layer), such as upon detecting certain traffic and/or QoS related events (e.g., latency increases above a threshold) when forwarding the PDUs in a first flow.

As another example, an association between data flows may vary and/or be determined at a combination of different dimensions and/or domains including the time domain (e.g., association may be applicable over a time window and/or duration), the frequency domain (e.g., association may be applicable when transmissions and/or receptions are performed over a set of channels, carriers, links, and/or frequency resources), and/or spatial domain (e.g., common location and/or area from where the data flows may originate from or intended/destined to, and/or common set of beams used for transmitting and/or receiving the flows). The WTRU may perform certain actions when determining any changes to the association between data flows in different dimensions and/or domains. Any indication and/or trigger may be configured in the WTRU for determining the association between one or more data flows in the UL and/or the DL and/or the corresponding actions for ensuring coordinated transmissions/receptions of the associated flows may include any of the following:
Change in achievable and/or expected QoS
   For example, a WTRU may determine whether one or more flows may be associated and/or whether a corresponding action may be performed upon detecting certain changes in achievable and/or expected QoS related measurements (e.g., latency and/or data rate increases above a threshold, and/or latency and/or data rate decreases below a threshold) in any of the associated flows;
Change in channel/link measurements
   For example, a WTRU may determine whether any actions may be performed when transmitting and/or receiving data in different associated flows, such as upon detecting certain changes in measurements related to channels, links, and/or beams used during the transmission and/or reception of the data flows (e.g., RSRP measurements increase and/or decrease above or below a threshold). For example, upon detecting deterioration in measurements made on a first channel (e.g., CSI-RS associated with a first resource set and/or beam set) used for transmitting data in a first flow, the WTRU may perform certain actions (e.g., drop and/or suspend transmissions) when transmitting data in a second flow using a second channel (e.g., second resource set and/or beam set). For example, the WTRU may perform actions for transmitting data in the second flow irrespective of whether the second channel may be experiencing any deterioration.
Receiving indications from a network and/or higher layers
   For example, a WTRU may determine whether any actions may be performed upon receiving (e.g., from a network and/or higher layers) one or more indications and/or one or more notifications indicating any change (e.g., changes) related to traffic forwarding and/or delivery of data in any of the associated flows. An indication and/or notification may include any of a status report, feedback (e.g., HARQ ACK/NACK), flow control indications, an error rate (e.g., PER for PDUs or PDU set), and/or uncertainty information (e.g., due to estimation and/or prediction of QoS). For example, the one or more indications and/or notifications may be used by the WTRU to determine whether (e.g., joint) QoS requirements may be met for the associated flows.
Timer/Periodic
   For example, a WTRU may be configured with a timer (e.g., a time duration and/or periodicity) for determining whether any action may be performed. The timer (e.g., time duration and/or periodicity) may be applied when detecting one or more events (e.g., a delay between reception of a first PDU in first flow and a first PDU in a second flow is greater (or less) than a threshold) related to and/or associated with data flows. As an example, a WTRU may start a timer (e.g., determine a start of the time duration and/or interval) upon detecting an associated event and/or may determine a corresponding action before the expiry of the timer (e.g., lapse of the time duration and/or interval). As another example, a WTRU may be configured to (e.g., periodically) determine whether an action may be performed based on (e.g., periodically) determining the association between one or more flows in UL and/or DL.

In certain representative embodiments, a WTRU may perform actions for ensuring joint QoS requirements may be met based on a determination of an association between data flows during UL transmissions and/or DL receptions. For example, a WTRU may perform any (e.g., a combination) of one or more of the following actions:
Perform QoS compensation during data forwarding in associated flows:
   For example, a WTRU may be configured with one or more resource (e.g., forwarding) configurations (e.g., radio bearer configurations, LCHs configurations, and/or resource configurations such as configured grants, BWPs). Upon detecting any events (e.g., an actual QoS is different than an expected QoS), that may result in impacting the synchronization during data transmission and/or reception and/or association between the flows, the WTRU may select a pre-configured forwarding configuration for compensating for the change in QoS in one or more associated flows.
   For example, upon detecting a delayed reception and/or transmission of one or more PDUs in a first flow, a WTRU may select a pre-configured forwarding configuration (e.g., a new configured grant with higher periodicity and/or payload size). The WTRU may select a forwarding configuration based on a determination of a difference between a delay incurred for PDUs in the associated second flow and the associated first flow (e.g., the PDUs in the first flow may be transmitted to catch up with the PDUs in second flow while reducing and/or minimizing the difference in the delay). For example, a WTRU may send an indication to the network requesting to activate a (e.g., preconfigured) forwarding configuration and/or configure a (e.g., new) forwarding configuration for compensating the QoS.
   For example, upon detecting a delayed transmission of one or more PDUs in a first flow, a WTRU may decide whether to transmit and/or drop the transmission of one or more PDUs in an associated second flow (e.g., based on one or more criteria). A WTRU may determine whether to receive PDUs in a first flow when the reception of PDUs in an associated second flow may be delayed (e.g., based on one more criteria). A criterion (e.g., condition) for making a determination (e.g., whether to transmit, receive, drop and/or skip the PDUs) may include a degree of association between the flows (e.g., fully or partially associated based on an association value), priority and/or importance of the PDUs in the associated flows, and/or an amount of difference between the QoS achievable for the PDUs in the associated flows. For example, when a priority value of the PDUs in the second flow is greater than a threshold, the WTRU may decide to transmit and/or receive the PDUs, such as upon detecting a delay during the transmission and/or reception of PDUs in first flow. For example, when a priority value of the PDUs in the second flow is less than a threshold, the WTRU may decide to drop the transmission and/or skip the reception of the PDUs in the second flow, when the PDUs in first flow are delayed.
Readjust/realign QoS in associated flows, and/or
   For example, a WTRU may determine an adjustment amount (e.g., readjustment and/or realignment) that may be applied for a QoS of one or more flows when detecting a change in achievable QoS in one or more other associated flows (e.g., during data transmission and/or reception).
   For example, upon a WTRU detecting an increase or decrease in QoS (e.g., data rate and/or latency) by a certain amount (e.g., greater or less than a threshold) in a first flow, the WTRU may determine a corresponding increase or decrease in QoS for an associated second flow, such as based on the association between the flows. On condition that the QoS of a first flow decreases by X %, a WTRU may determine (e.g., infer) that the QoS of the second flow may also decrease by X %. The UE may determine a (e.g., similar or corresponding) amount of alignment and/or adjustment to the QoS in the second flow, such as by indicating to the network to a change in forwarding configurations to align the QoS and/or to change the forwarding configuration parameters to match the determined amount (e.g., align the QoS such that the QoS in both flows).
   For example, a WTRU may determine an offset amount to a start time (e.g., of a slot, mini-slot, sub-frame, frame or other TTI) for periodic data transmission of a first flow using first resources (e.g., a first configured grant) based on a determination of a (e.g., similar or corresponding) offset amount for starting periodic data transmission of an associated second flow using second resources (e.g., a second configured grant). A WTRU may send an indication to the network (e.g., in RRC, MAC CE, and/or UCI) indicating the determined offset amount for the first and/or second configured grant configurations, for example.
Sends indications and/or information on associated flows to a network
   For example, a WTRU may send one or more indications to a network (e.g., in RRC, MAC CE, and/or UCI) based on detection of one or more events and/or triggers. The one or more events and/or triggers may be associated with (e.g., ensuring) synchronization and/or association of different flows. The one or more indications may include any of: a request for assistance for synchronizing transmission and/or reception of data in multiple associated flows, a request for configuring (e.g., new) forwarding configurations, a request for updating and/or changing parameters of pre-configured forwarding configurations, a request for activating and/or deactivating any of parameters and/or configurations of selected forwarding configurations, and/or a request for releasing any forwarding configurations.

### Indications for Changing Resource Configurations

In certain representative embodiments, a WTRU may send one or more indications (e.g., in RRC, MAC CE, and/or UCI) to a network. For example, a WTRU may send information indicating any of: an inability to determine and/or select a suitable forwarding configuration, updating the QoS during subsequent transmissions and/or receptions for a set of one or more previously transmitted PDUs in different flows, and/or dropping of a set of one or more previously transmitted PDUs.

In certain representative embodiments, a WTRU may be configured with one or more resource configurations. The one or more resource configurations may include one or more configured grant (CG) configurations and/or one or more semi-persistent scheduling (SPS) configurations. A CG configuration may include one or more CG parameters (e.g., start offset time, periodicity, payload size), such as for ensuring data transmissions in UL and/or receptions in DL for one or more associated flows may be performed within a synchronization RTT window. A SPS configuration may include one or more SPS parameters (e.g., start offset time, periodicity, payload size), such as for ensuring the data transmissions in UL and/or receptions in DL for one or more associated flows may be performed within a synchronization RTT window. A RTT latency (e.g., of a given data flow) may be measured between transmission of one or more PDUs (e.g., a PDU set or ADU) in UL and reception of one or more PDUs (e.g., a PDU set or ADU) in the DL. For example, a RTT latency may be measured between the transmission of one or more PDUs in the UL during an active time of a CG configuration and the reception of one or more PDUs in the DL (e.g., associated with the UL transmission) during an active time of an SPS configuration.

In certain representative embodiments, a synchronization RTT window may refer to a RTT time difference between transmission and reception of one or more PDUs (e.g., a PDU set or ADU) in a (e.g., associated) first flow and transmission and reception of one or more PDUs (e.g. PDU set or ADU) in a (e.g., associated) second flow. A WTRU may be configured with a (e.g., joint) QoS requirement. For example, the QoS requirement may ensure that the synchronization RTT window (e.g., multi-flow RTT time difference between multiple flows) remains above (or below) a threshold value. A WTRU may be configured to monitor whether any change is observed in the per-flow RTT for each flow and/or the multi-flow RTT time difference (e.g., between the different associated flows). Based on the monitoring, the WTRU may determine whether any changes may be applied to the parameters of resource configurations (e.g., CG and/or SPS configuration) and/or to select a set of (e.g., new or preconfigured) resource configurations (e.g., CG and/or SPS configurations) that may ensure meeting the (e.g., joint) QoS requirement (e.g., the RTT time difference is below a threshold and/or remains within a range).

In certain representative embodiments, a WTRU may be configured by the network with one or more resource configurations based on statistical information (e.g., average, standard deviation, minimum, maximum) related to the RTT latency of different associated flows. For example, the WTRU may provide and/or indicate the statistical information in assistance information to a base station in a RAN and/or a CN function (e.g., AMF, SMF). The one or more resource configurations may include one or more configured grant (CG) configurations and/or one or more semi-persistent scheduling (SPS) configurations. For example, the WTRU may (e.g., also) be configured with (1) one or more per-flow RTT threshold values for one or more flows (e.g., corresponding to maximum or minimum difference in latency from an average/expected RTT latency value) and/or (2) one or more multi-flow RTT time difference threshold values between different associated flows. For example, the WTRU may (e.g., also) be configured with information indicating associations between the per-flow RTT threshold values and/or the multi-flow RTT threshold values with the resource configurations (e.g., CG and/or SPS configurations). For example, the information may (e.g., also) indicate a validity of using any of the CG and/or SPS configuration when transmitting and/or receiving data within a per-flow RTT threshold and/or within the multi-flow RTT threshold. As another example, the information may (e.g., also) indicate the parameters (e.g., offset values, periodicity) of the CG and/or SPS configurations that may be changed, such as to realign the CG and/or SPS configurations with changes in the per-flow RTT and/or multi-flow RTT.

In certain representative embodiments, one or more (e.g., triggering) events and/or conditions may be monitored by a WTRU. Monitoring of the events and/or conditions may be performed by a WTRU for determining whether any resource configurations and/or parameters of resource configurations (e.g., for CG and/or SPS) may be changed, such as for meeting the per-flow RTT latency and/or multi-flow RTT latency. For example, the (e.g., triggering) events and/or conditions may include any of the following:
Connectivity and/or session (re)configuration
   For example, when receiving and/or transmitting any signaling messages associated with (re)configuration of RRC connection, RRC state, PDU session, and/or application layer session for one or more associated flows;
   For example, when changing a RRC state of a WTRU from RRC CONNECTED to RRC INACTIVE or IDLE or vice-versa;
Reception of a higher layer and/or application layer indication
   For example, when receiving an indication from any higher layers, from one or more PDUs (e.g., information in a header of one or more PDUs) of one or more associated flows, and/or from network information indicating any of the following changes in upcoming data which may be transmitted and/or received using any of the CG and/or SPS configurations:
      Data type (e.g., upcoming frame changes from P/B-frame to I-frame);
      Priority, importance and/or relative priority and/or importance of data type (e.g., I-frame or P-frame);
      Failed higher layer frame (e.g., the application layer has failed to decode an I-frame);
      Traffic characteristics (e.g., a number of PDUs in a PDU set is expected or determined to be above or below a threshold value, PDB or PDU set delay bound is expected or determined to be above or below a threshold, PER or PDU set error rate is expected or determined to be above or below a threshold, and/or frame rate increases above or decreases below a threshold);
      Priority of data (e.g., a priority value of PDUs or PDU sets is expected or determined to be above or below a threshold);
      QFI and/or or any QoS indication and/or marking (e.g., QFI value is expected or determined to be greater or lower than a threshold);
Time duration, interval and/or periodicity
   For example, a WTRU may determine whether any of the CG and/or SPS configurations may be changed when a timer (e.g., duration and/or interval) configured to monitor the per-flow RTT latency and/or multi-flow RTT latency is started and/or lapses. As another example, a WTRU may periodically determine a change to the CG and/or SPS configurations for meeting the RTT latencies. The periodicity maybe based on a configured periodicity (e.g., periodicity associated with a frame rate);
Changing and/or updating data flows per application
   For example, when adding one or more (e.g., new) flows and/or releasing (e.g., existing) flows associated with an application;
Jitter measurement
   For example, when a measured jitter value (e.g., a difference between an expected time slot or other TTI when data is expected to be received and an actual time slot or other TTI when the data is actually received) in one or more data flows is above or below a threshold value;
Radio link measurement
   For example, when RSRP, RSRQ, and/or RSSI measurements of signals, channels, beams, carriers, and/or links, etc., (e.g., associated with one or more data flows transmitted and/or received by a WTRU) are above and/or below threshold values;
Change in movement, and/or
   For example, a WTRU may determine pose/positioning measurements (e.g., location information and/or pose in 6DoF) are above and/or below pose and/or location threshold values;
Change in power saving configuration
   For example, when changing any of parameters and/or configurations associated with CDRX and/or DRX (e.g., cycle duration, on time, and/or inactive time) used during transmission and/or reception of data in different flows.

In certain representative embodiments, a WTRU may determine a per-flow RTT and/or multi-flow RTT latency of associated data flows. For example, on condition that a WTRU is configured with one or more resource (e.g., CG and/or SPS) configurations, the WTRU may determine a per-flow RTT and/or multi-flow RTT latency based on measurement of a time difference between the transmission and/or reception of PDUs in different associated flows or based on another indication received from a higher layer and/or a network. For example, a WTRU may compare a measured per-flow RTT and/or a multi-flow RTT latency with respect to a set of (e.g., configured) threshold values for determining whether any of the resource (e.g., CG and/or SPS) configurations are valid for transmitting and/or receiving data. For example, on condition a WTRU determines that the per-flow RTT and/or multi-flow RTT latency is above and/or below a set of configured threshold values, the WTRU may send an indication and/or request (e.g., via RRC message, MAC CE, and/or UCI) to the network to change the parameters of the resource (e.g., CG and/or SPS) configurations or select a (e.g., new) resource (e.g., CG and/or SPS) configuration, such that the data transmission and/or reception in different flows may be aligned with the determined per-flow RTT latency and/or multi-flow RTT latency.

In an example, when determining the per-flow RTT latency for a first flow to be higher than a threshold, a WTRU may infer a similar and/or corresponding (e.g., comparable) change in the per-flow RTT latency for an associated second flow. Upon determining the change in per-flow RTT latency, the WTRU may determine one or more updates and/or changes to the resource (e.g., CG and/or SPS) configurations and/or parameters thereof that may be made for (re)aligning the transmissions/receptions of the PDUs in both flows (e.g., the first and second flows), such that the multi-flow RTT latency remains below a threshold value. The WTRU may send an (e.g., explicit or implicit) indication to the network (e.g. in RRC, MAC CE, and/or UCI) indicating the determined changes to the resource (e.g., CG and/or SPS) configurations and/or perform data transmission and/or reception in the different data flows with the updated and/or changed resource configurations. For example, the WTRU may perform data transmission and/or reception in the different data flows with the updated and/or changed resource configurations after receiving an (e.g., explicit or implicit) indication and/or confirmation (e.g. in RRC, MAC CE, and/or DCI) from the network. As another example, the WTRU may perform data transmission and/or reception in the different data flows with the updated and/or changed resource configurations after timer has expired (e.g., lapse of a time duration).

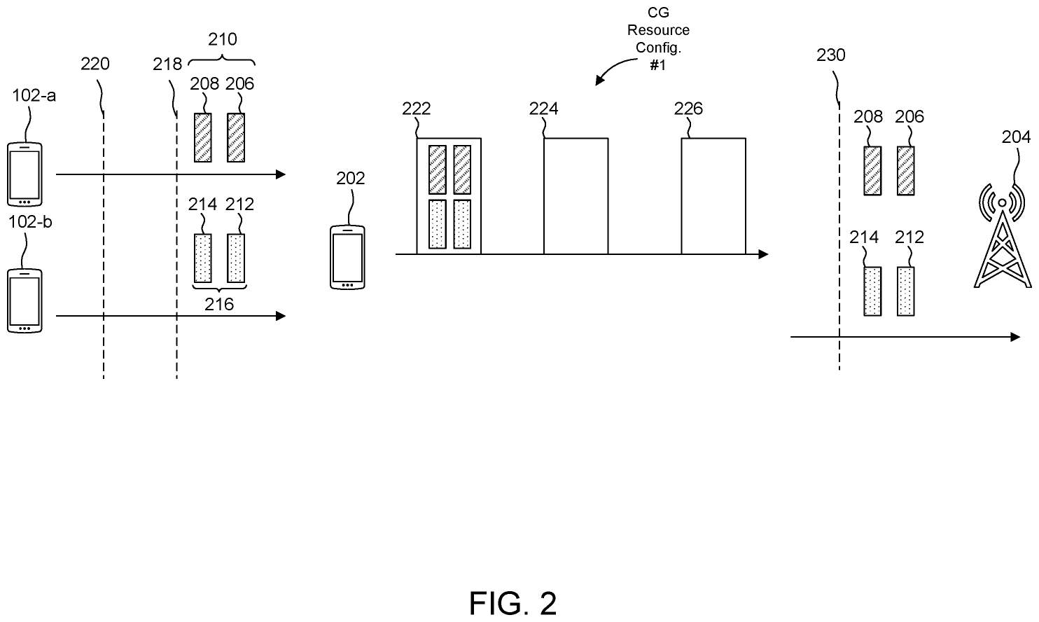

FIG. 2 is a system diagram illustrating an example of multi-flow synchronization that may be used within the communications systems described herein. In FIG. 2, one or more devices, such as WTRUs 102-a and/or 102-b, may (e.g., as a group or individually) send multiple flows, such as via sidelink using an anchor or relay WTRU 202, to a base station 204 (e.g., a gNB 180). For example, a first flow may comprise a plurality of PDUs, such as a first PDU 206 and a second PDU 208. In certain representative embodiments, the PDUs comprising the first flow may form a plurality of ADUs, such as the first PDU 206 and the second PDU belonging to a first ADU 210 of the first flow. For example, a second flow may comprise a plurality of PDUs, such as a first PDU 212 and a second PDU 214. In certain representative embodiments, the PDUs comprising the first flow may form a plurality of ADUs, such as the first PDU 212 and the second PDU 214 belonging to a second ADU 216 of the second flow. The WTRU 202 may be configured with a synchronization time window (e.g., interval). The WTRU 202 may be configured with at least a first resource configuration. For example, a first threshold (e.g., time point) 218 and a second threshold (e.g., time point) 220 may form or define the synchronization time window.

In FIG. 2, the WTRU 202 may receive the PDUs 206, 208, 212, 214 from the WTRU 102-a and/or the WTRU 102-b before the first threshold and the second threshold have lapsed (e.g., from a previous ADU of the first and/or second flows). The WTRU 202 may proceed to transmit (e.g., forward) the PDUs 206, 208, 212, 214 using the first resource configuration. For example, the first resource configuration may be a configured grant (CG) resource configuration which includes resources for a plurality of transmission occasions 222, 224, 226, etc. In FIG. 2, the WTRU 202 may transmit the PDUs 206, 208, 212, 214 using a transmission occasion 222 to the base station 204. For example, the first transmission occasion 222 may ensure synchronization between the first and second flows such that the PDUs 208, 206, 212, 214 which are transmitted using the first transmission occasion 222 are received at the base station 204 within a third threshold 230 (e.g., latency between PDUs, ADUs and/or flows) from the perspective of the base station 204.

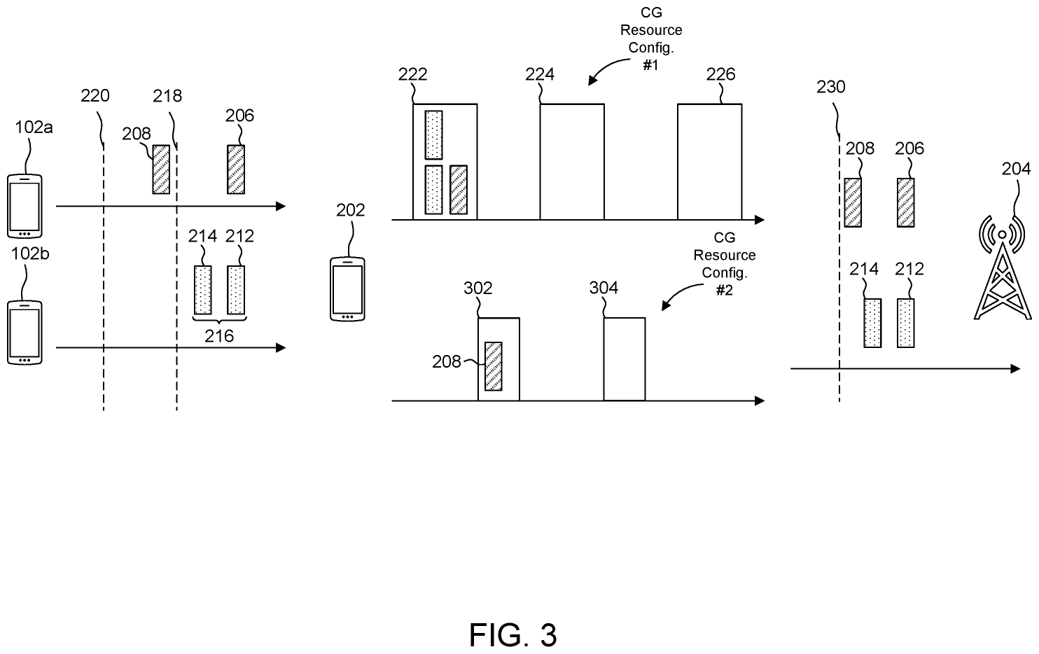

FIG. 3 is a system diagram illustrating another example of multi-flow synchronization that may be used within the communications systems described herein. In FIG. 3, one or more devices, such as the WTRUs 102-a and/or 102-b, may (e.g., as a group or individually) send multiple flows, such as via sidelink using the anchor or relay WTRU 202, to the base station 204 (e.g., a gNB 180). For example, the first flow may comprise a plurality of PDUs, such as a first PDU 206 and a second PDU 208. In certain representative embodiments, the PDUs comprising the first flow may form a plurality of ADUs, such as the first PDU 206 and the second PDU belonging to the first ADU 210 of the first flow. For example, the second flow may comprise a plurality of PDUs, such as a first PDU 212 and a second PDU 214. In certain representative embodiments, the PDUs comprising the first flow may form a plurality of ADUs, such as the first PDU 212 and the second PDU 214 belonging to the second ADU 216 of the second flow. The WTRU 202 may be configured with the synchronization time window (e.g., interval). The WTRU 202 may be configured with at least a first resource configuration and a second resource configuration. For example, the first threshold (e.g., time point) 218 and the second threshold (e.g., time point) 220 may form or define the synchronization time window.

In FIG. 3, the WTRU 202 may receive the PDUs 206, 208, 212, 214 from the WTRU 102-a and/or the WTRU 102-b after the first threshold has lapsed and before the second threshold has lapsed (e.g., from a previous ADU of the first and/or second flows). The WTRU 202 may proceed to transmit (e.g., forward) the PDUs 206, 212, 214 using the first resource configuration. For example, the first resource configuration may be a configured grant (CG) resource configuration which includes resources for a plurality of transmission occasions 222, 224, 226, etc. In FIG. 3, the WTRU 202 may transmit the PDUs 206, 212, 214 using a transmission occasion 222 to the base station 204. Due to the PDU 208 being received by the WTRU 202 after the first threshold 218 but before the second threshold 220, the WTRU 202 may proceed to transmit (e.g., forward) the PDU 208 using the second resource configuration. For example, the second resource configuration may be a configured grant (CG) resource configuration which includes resources for a plurality of transmission occasions 302, 304, etc. In FIG. 3, the WTRU 202 may transmit the PDU 208 using a transmission occasion 302 (e.g., subsequent to transmission occasion 222) to the base station 204. For example, the use of transmission occasions 222 and 302 may ensure synchronization between the first and second flows such that the PDUs 206, 212, 214 which are transmitted by the WTRU 202 are received at the base station 204 within a third threshold 230 (e.g., latency between PDUs, ADUs and/or flows) from the perspective of the base station 204.

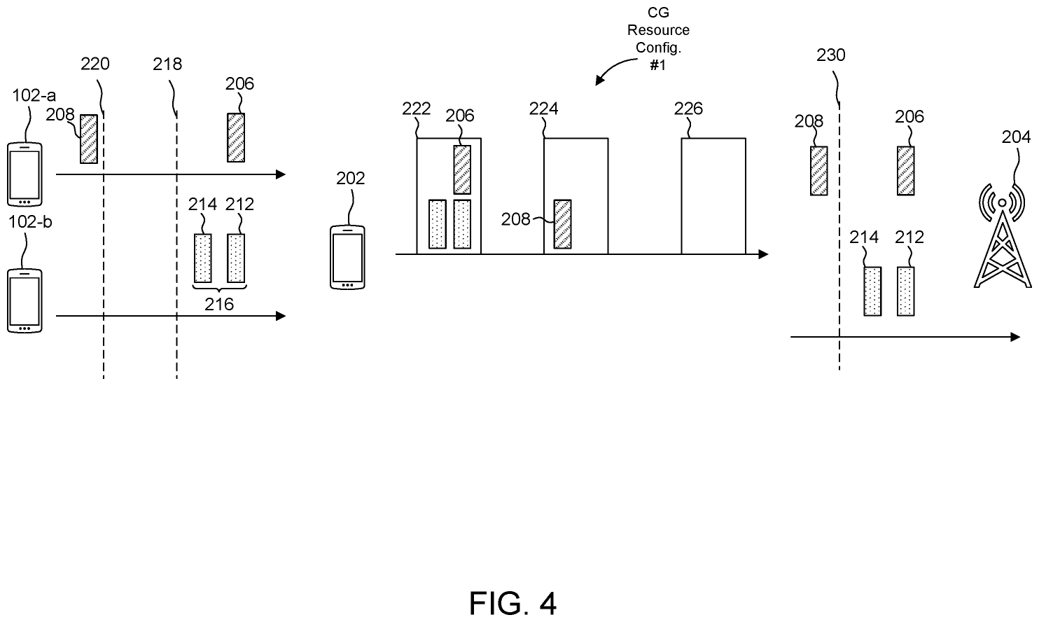

FIG. 4 is a system diagram illustrating a further example of multi-flow synchronization that may be used within the communications systems described herein. In FIG. 4, one or more devices, such as the WTRUs 102-a and/or 102-b, may (e.g., as a group or individually) send multiple flows, such as via sidelink using the anchor or relay WTRU 202, to the base station 204 (e.g., a gNB 180). For example, the first flow may comprise a plurality of PDUs, such as a first PDU 206 and a second PDU 208. In certain representative embodiments, the PDUs comprising the first flow may form a plurality of ADUs, such as the first PDU 206 and the second PDU belonging to a first ADU 210 of the first flow. For example, the second flow may comprise a plurality of PDUs, such as a first PDU 212 and a second PDU 214. In certain representative embodiments, the PDUs comprising the first flow may form a plurality of ADUs, such as the first PDU 212 and the second PDU 214 belonging to a second ADU 216 of the second flow. The WTRU 202 may be configured with a synchronization time window (e.g., time interval). The WTRU 202 may be configured with at least a first resource configuration. For example, a first threshold (e.g., time point) 218 and a second threshold (e.g., time point) 220 may form or define the synchronization time window.

In FIG. 4, the WTRU 202 may receive the PDUs 206, 212, 214 from the WTRU 102-a and/or the WTRU 102-b before the first threshold and the second threshold have lapsed (e.g., from a previous ADU of the first and/or second flows). The WTRU 202 may receive the PDU 208 after the first threshold and the second threshold have lapsed (e.g., outside the synchronization time window). The WTRU 202 may proceed to transmit (e.g., forward) the PDUs 206, 208, 212, 214 using the first resource configuration. For example, the first resource configuration may be a configured grant (CG) resource configuration which includes resources for a plurality of transmission occasions 222, 224, 226, etc. In FIG. 4, the WTRU 202 may transmit the PDUs 206, 212, 214 using a transmission occasion 222 to the base station 204. For example, the first transmission occasion 222 may ensure synchronization between the first and second flows such that the PDUs 206, 212, 214 which are transmitted using the first transmission occasion 222 are received at the base station 204 within a third threshold 230 (e.g., latency between PDUs, ADUs and/or flows) from the perspective of the base station 204. Further, the WTRU 202 may transmit at least the PDU 208 using the transmission occasion 224 to the base station 204. Due to the PDU 208 being received after the first and second thresholds, synchronization may not be ensured between the first and second flows such that the PDU 208 is received at the base station 204 outside of or after the third threshold 230.

In certain representative embodiments, multiple flows may synchronized on a per PDU basis and/or a per ADU basis as in FIGS. 2-4. In other representative embodiments, flow synchronization may be performed on a basis other than PDUs or ADUs, such as, but not limited to, sets of PDUs.

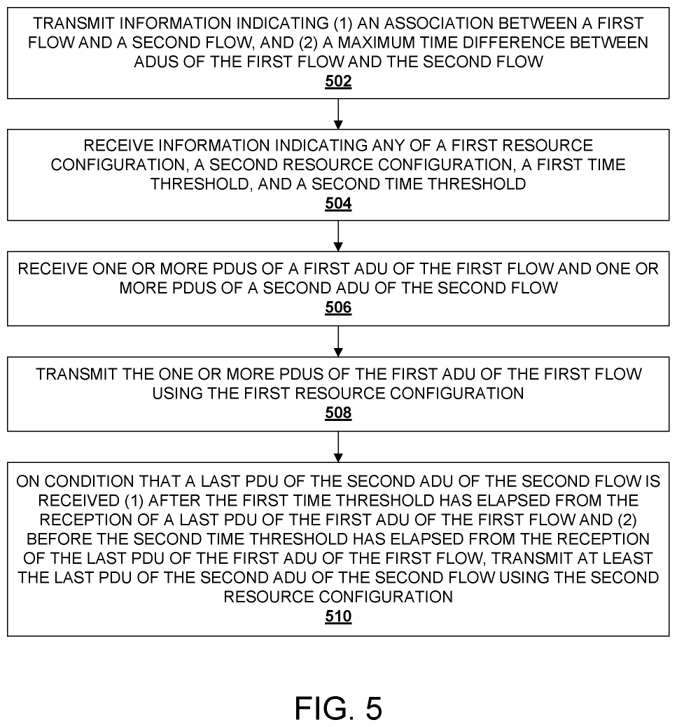

FIG. 5 is a procedural diagram illustrating an example procedure for synchronizing multiple flows. In certain representative embodiments, the procedure in FIG. 5 may be implemented generally by a WTRU 102, such as the WTRU 202. At 502, a WTRU 102 may transmit (e.g., to a base station 204) information indicating (1) an association between a first flow and a second flow, and (2) a maximum time difference between ADUs of the first flow and the second flow. At 504, the WTRU 102 may receive (e.g., from the base station) information indicating any of a first resource configuration, a second resource configuration, a first time threshold, and/or a second time threshold (e.g., greater than the first time threshold). After 504, the WTRU 102 may receive one or more PDUs of a first ADU of the first flow and one or more PDUs of a second ADU of the second flow (e.g., from a higher layer, another WTRU 102) at 506. At 508, the WTRU 102 may transmit (e.g., to or towards the base station 204) the one or more PDUs of the first ADU of the first flow using the first resource configuration. At 510, on condition that a last PDU of the second ADU of the second flow is received (1) after the first time threshold has elapsed from the reception of a last PDU of the first ADU of the first flow and (2) before the second time threshold has elapsed from the reception of the last PDU of the first ADU of the first flow, the WTRU 102 may transmit at least the last PDU of the second ADU of the second flow using the second resource configuration.

In certain representative embodiments, the first resource configuration may be a first configured grant configuration, and the second resource configuration may be a second configured grant configuration. For example, a size of transmission occasions (e.g., time and/or frequency resources) associated with the first resource configuration is larger than a size of transmission occasions associated with the second resource configuration. For example, the first resource configuration may include a first plurality of transmission occasions having a first periodicity, and the second resource configuration may include a second plurality of transmission occasions having a second periodicity which is less than the first periodicity.

In certain representative embodiments, the transmitting of the one or more PDUs of the first ADU of the first flow using the first resource configuration may include transmitting the one or more PDUs of the first ADU of the first flow and one or more PDUs of the second ADU received before the last PDU of the second ADU using a (e.g., single) transmission occasion according to the first resource configuration.

In certain representative embodiments, the transmitting of at least the last PDU of the second ADU of the second flow using the second resource configuration has a timing offset which is after the transmitting the one or more PDUs of the first ADU of the first flow using the first resource configuration.

In certain representative embodiments, the first resource configuration may be associated with the first flow and/or the second flow. In certain representative embodiments, any of the second resource configuration, the first time threshold, and/or the second time threshold may be associated with the first flow and/or the second flow.

In certain representative embodiments, the ADUs of the first flow and the second flow are received by a WTRU 102 from another WTRU 102 (e.g., using sidelink resources).

In certain representative embodiments, the second ADU of the second flow may correspond to the first ADU of the first flow, and/or vice versa. For example, the one or more PDUs of the first ADU of the first flow may include identification, timing and/or sequence information associated with the first ADU. For example, the one or more PDUs of the second ADU of the second flow may include identification, timing and/or sequence information associated with the second ADU. The identification, timing, and/or sequence information may indicate a correspondence between the PDUs and/or the ADUs.

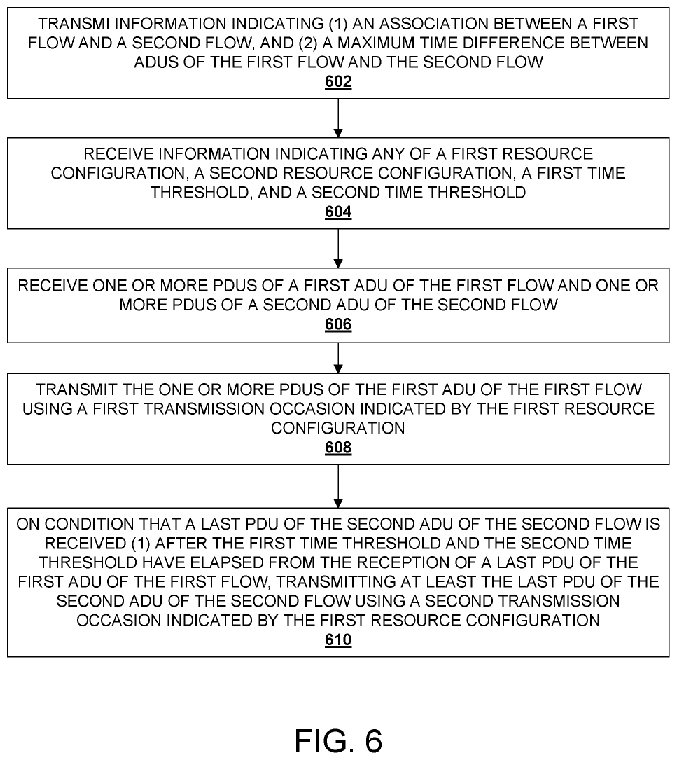

FIG. 6 is a procedural diagram illustrating another example procedure for synchronizing multiple flows. In certain representative embodiments, the procedure in FIG. 6 may be implemented generally by a WTRU 102, such as the WTRU 202. In FIG. 6, a WTRU 102 may transmit (e.g., to a base station) information indicating (1) an association between a first flow and a second flow, and (2) a maximum time difference between ADUs of the first flow and the second flow at 602. At 604, the WTRU 102 may receive (e.g., from the base station) information indicating any of a first resource configuration, a second resource configuration, a first time threshold, and a second time threshold (e.g., greater than the first time threshold). At 606, the WTRU 102 may receive one or more PDUs of a first ADU of the first flow and one or more PDUs of a second ADU of the second flow. After 606, the WTRU may transmit (e.g., to or towards a base station) the one or more PDUs of the first ADU of the first flow using a first transmission occasion indicated by the first resource configuration at 608. At 610, on condition that a last PDU of the second ADU of the second flow is received (1) after the first time threshold and the second time threshold have elapsed from the reception of a last PDU of the first ADU of the first flow, the WTRU 102 may transmit at least the last PDU of the second ADU of the second flow using a second transmission occasion indicated by the first resource configuration.

In certain representative embodiments, the first resource configuration may be a first configured grant configuration, and/or the second resource configuration may be a second configured grant configuration. For example, a size of transmission occasions (e.g., time and/or frequency resources) associated with the first resource configuration may be larger than a size of transmission occasions associated with the second resource configuration. For example, the first resource configuration may include a first plurality of transmission occasions having a first periodicity, and/or the second resource configuration may include a second plurality of transmission occasions having a second periodicity which is less than the first periodicity.

In certain representative embodiments, the transmitting of the one or more PDUs of the first ADU of the first flow using the first transmission occasion of the first resource configuration may include transmitting at least one other PDU of the second ADU of the second flow, which is received before the last PDU of the second ADU, using the first transmission occasion of the first resource configuration.

In certain representative embodiments, the first resource configuration may be associated with the first flow and/or the second flow. In certain representative embodiments, any of the first time threshold, and/or the second time threshold may be associated with the first flow and/or the second flow.

In certain representative embodiments, the ADUs of the first flow and the second flow are received by the WTRU 102 from another WTRU 102 (e.g., using sidelink resources).

In certain representative embodiments, the second ADU of the second flow may correspond to the first ADU of the first flow, and/or vice versa. For example, the one or more PDUs of the first ADU of the first flow may include identification, timing and/or sequence information associated with the first ADU. The one or more PDUs of the second ADU of the second flow may include identification, timing, and/or sequence information associated with the second ADU. For example, the identification, timing, and/or sequence information may indicate correspondence between PDUs and/or ADUs of the flows.

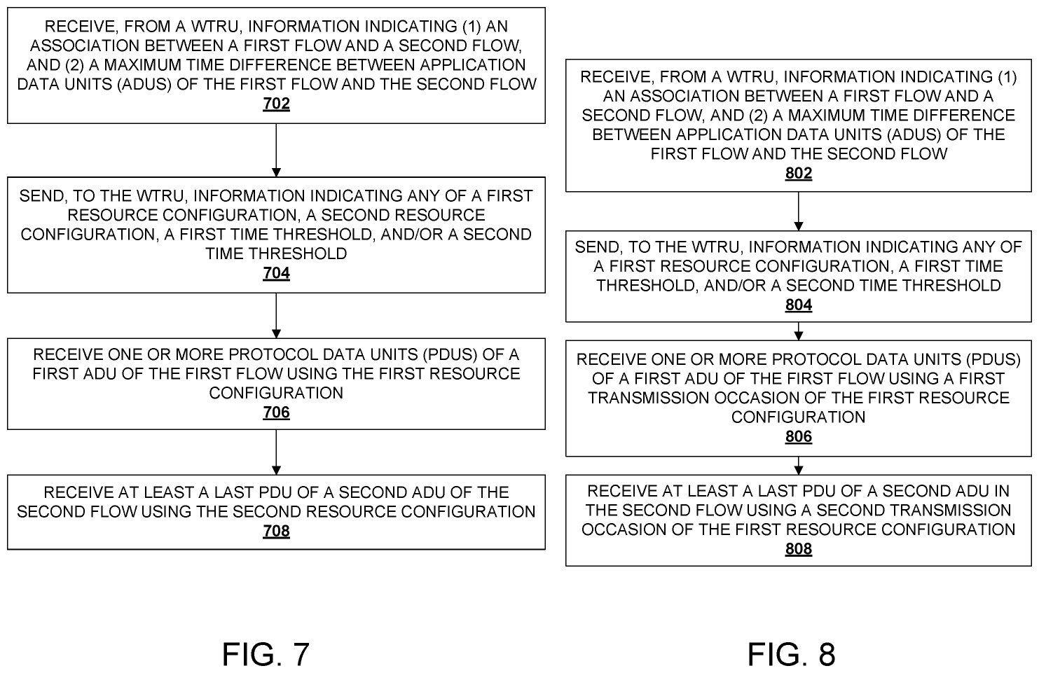

FIG. 7 is a procedural diagram illustrating an example procedure for synchronizing multiple flows. In certain representative embodiments, the procedure in FIG. 7 may be implemented generally by a base station, such as a gNB 180. At 702, the base station may receive, from a WTRU 102, information indicating (1) an association between a first flow and a second flow, and (2) a maximum time difference between ADUs of the first flow and the second flow. At 704, the base station may send, to the WTRU, information indicating any of a first resource configuration, a second resource configuration, a first time threshold, and/or a second time threshold. At 706, the base station may receive (e.g., from the WTRU 102) one or more PDUs of a first ADU of the first flow using the first resource configuration. At 708, the base station may receive (e.g., from the WTRU 102) at least a last PDU of a second ADU of the second flow using the second resource configuration. For example, the reception of the last PDU of the second ADU of the second flow using the second resource configuration may indicate (e.g., to the base station) that the last PDU of the second ADU of the second flow was received by the WTRU 102 (1) after the first threshold has elapsed from reception, by the WTRU 102, of a last PDU of the first ADU of the first flow and (2) before the second threshold has elapsed from the reception, by the WTRU 102, of the last PDU of the ADUs of the first flow.

FIG. 8 is a procedural diagram illustrating another example procedure for synchronizing multiple flows. In certain representative embodiments, the procedure in FIG. 8 may be implemented generally by a base station, such as a gNB 180. At 802, the base station may receive, from a WTRU 102, information indicating (1) an association between a first flow and a second flow, and (2) a maximum time difference between ADUs of the first flow and the second flow. At 804, the base station may send, to the WTRU 102, information indicating any of a first resource configuration, a first time threshold, and/or a second time threshold. At 806, the base station may receive (e.g., from the WTRU 102) one or more PDUs of a first ADU of the first flow using a first transmission occasion of the first resource configuration. At 808, the base station may receive (e.g., from the WTRU 102) at least a last PDU of a second ADU in the second flow using a second transmission occasion of the first resource configuration. For example, the reception of at least the last PDU of the second ADU in the second flow using the second transmission occasion may indicate (e.g., to the base station) that the last PDU of the second ADU of the second flow was received, by the WTRU 102, after the first threshold and the second threshold have elapsed from reception, by the WTRU 102, of a last PDU of the first ADU of the first flow.

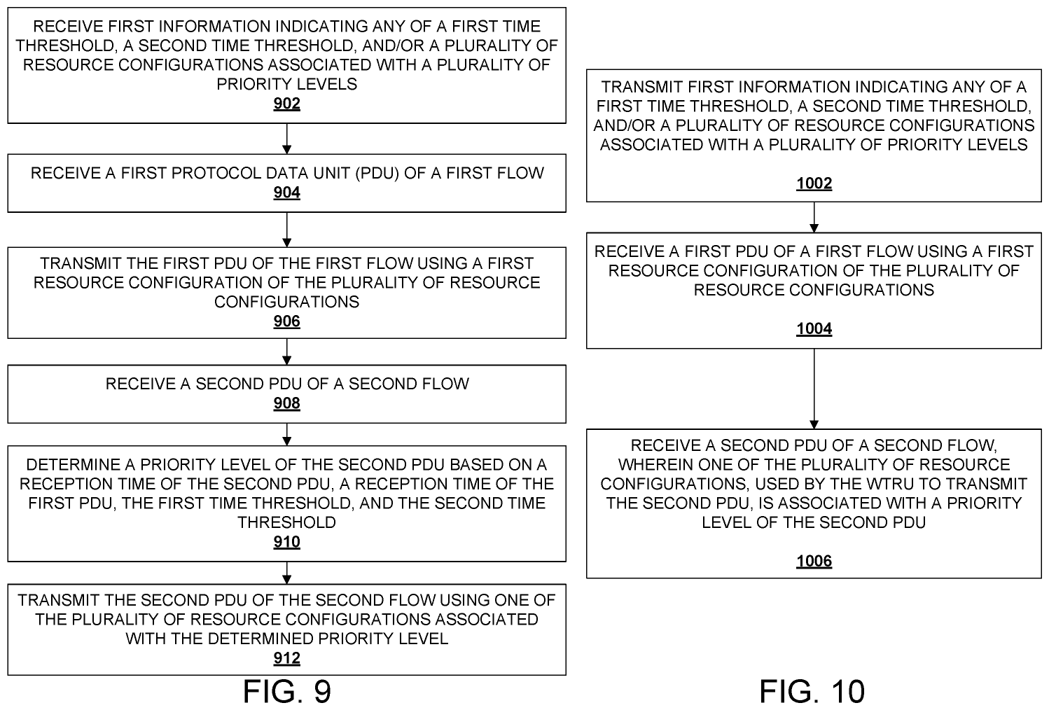

FIG. 9 is a procedural diagram illustrating an example for transmitting multiple flows using priority levels. In certain representative embodiments, the procedure in FIG. 9 may be implemented generally by a WTRU 102, such as the WTRU 202. At 902, the WTRU 102 may receive (e.g., from a base station) first information indicating any of a first time threshold, a second time threshold, and/or a plurality of resource configurations associated with a plurality of priority levels. At 904, the WTRU 102 may receive (e.g., from another WTRU 102 and/or a higher layer) a first protocol data unit (PDU) of a first flow. At 906, the WTRU 102 may transmit (e.g., to or towards the base station) the first PDU of the first flow using a first resource configuration of the plurality of resource configurations. At 908, the WTRU may receive (e.g., from another WTRU 102 and/or a higher layer) a second PDU of a second flow. At 910, the WTRU 102 may determine a priority level of the second PDU based on a reception time of the second PDU, a reception time of the first PDU, the first time threshold, and the second time threshold. At 912, the WTRU 102 may transmit the second PDU of the second flow using one of the plurality of resource configurations associated with the determined priority level.

In certain representative embodiments, the determining of the priority level of the second PDU may be based on a difference between the reception time of the second PDU and the reception time of the first PDU, the first time threshold, and the second time threshold as described herein. For example, the determined priority level may be a first priority level on condition that the difference is less than the first time threshold. The transmitting of the second PDU of the second flow may use the first resource configuration which is associated with the first priority level. For example, the transmitting of the first PDU and the transmitting of the second PDU may use one (e.g., single) transmission occasion indicated by the first resource configuration.

In certain representative embodiments, the determined priority level may be a second priority level on condition that the difference is greater than the first time threshold and less than the second time threshold. For example, the transmitting of the second PDU of the second flow may use a second resource configuration, of the plurality of resource configurations, which is associated with the second priority level. For example, the transmitting of the first PDU may use a first transmission occasion indicated by the first resource configuration, and the transmitting of the second PDU may use a second transmission occasion (e.g., subsequent to and/or offset from the first transmission occasion) indicated by the second resource configuration. For example, the second transmission occasion may be offset in time from the first transmission occasion.

In certain representative embodiments, the WTRU 102 may transmit (e.g., before the receiving of the first information) second information indicating an association between the first flow and the second flow.

In certain representative embodiments, the first PDU may be associated with a first ADU of the first flow, and/or the second PDU may be associated with a second ADU of the second flow. For example, the first PDU may include identification, timing and/or sequence information associated with the first ADU and/or first flow. For example, the second PDU may include identification, timing and/or sequence information associated with the second ADU and/or second flow. For example, the identification, timing, and/or sequence information may be used to determine a correspondence between the PDUs.

In certain representative embodiments, information included in the second ADU information is associated with information included in the first ADU.

FIG. 10 is a procedural diagram illustrating an example for receiving multiple flows using priority levels. In certain representative embodiments, the procedure in FIG. 10 may be implemented generally by a base station, such as a gNB 180. At 1002, the base station may transmit (e.g., to a WTRU 102), first information indicating any of a first time threshold, a second time threshold, and/or a plurality of resource configurations associated with a plurality of priority levels). At 1004, the base station may receive (e.g., from the WTRU 102) a first PDU of a first flow using a first resource configuration of the plurality of resource configurations. At 1008, the base station may receive (e.g., from the WTRU 102) a second PDU of a second flow. For example, the one of the plurality of resource configurations used (e.g., by the WTRU 102) to transmit the second PDU, may be associated with a priority level of the second PDU. For example, the priority level of the second PDU may be indicative (e.g., to the base station) of a relationship between a reception time of the second PDU (e.g., by the WTRU 102), a reception time of the first PDU (e.g., by the WTRU 102), the first time threshold, and the second time threshold.

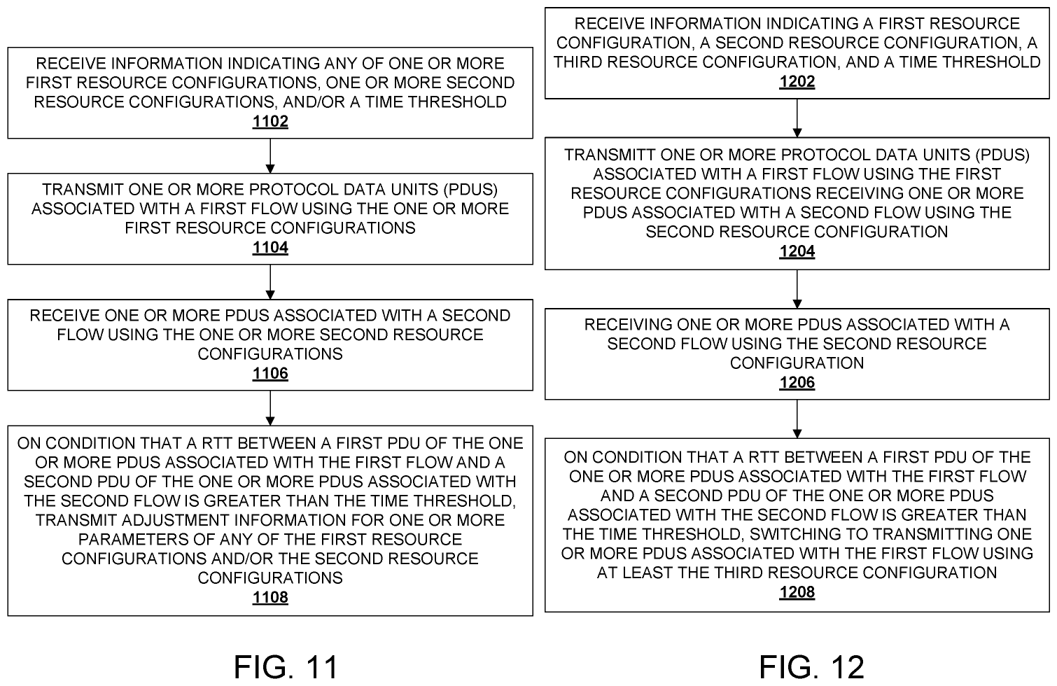

FIG. 11 is a procedural diagram illustrating an example procedure for adjusting resource configuration information for synchronizing multiple flows. In certain representative embodiments, the procedure in FIG. 11 may be implemented generally by a WTRU 102, such as the WTRU 202. At 1102, the WTRU 102 may receive (e.g., from a base station) information indicating any of one or more first resource configurations, one or more second resource configurations, and/or a time threshold. At 1104, the WTRU 102 may transmit (e.g., to the base station) one or more PDUs associated with a first flow using the one or more first resource configurations. At 1106, the WTRU 102 may receive (e.g., from the base station) one or more PDUs associated with a second flow using the one or more second resource configurations. After 1106, on condition that a RTT between a first PDU of the one or more PDUs associated with the first flow and a second PDU of the one or more PDUs associated with the second flow is greater than the time threshold, the WTRU 102 may transmit (e.g., to the base station) adjustment information for one or more parameters of any of the first resource configurations and/or the second resource configurations.

In certain representative embodiments, the adjustment information may be determined (e.g., by the WTRU 102) to ensure synchronization between the flows. For example, the adjustment information may indicate changes to the one or more parameters, such as to meet a joint QoS for the flows as described herein.

In certain representative embodiments, the first resource configurations may include one or more CG configurations. In certain representative embodiments, the second resource configurations may include one or more SPS configurations.

In certain representative embodiments, the adjustment information may include information indicating changes to any of an offset time, a periodicity, payload size, and/or amount of time/frequency resources.

In certain representative embodiments, the one of first resource configurations may be associated with different priority levels as described herein.

FIG. 12 is a procedural diagram illustrating another example procedure for adjusting resource configuration information for synchronizing multiple flows. In certain representative embodiments, the procedure in FIG. 12 may be implemented generally by a WTRU 102, such as the WTRU 202. At 1202, the WTRU 102 may receive (e.g., from a base station) information indicating any of a first resource configuration, a second resource configuration, a third resource configuration, and/or a time threshold. At 1204, the WTRU 102 may transmit (e.g., to a base station) one or more PDUs associated with a first flow using the first resource configurations. At 1206, the WTRU may receive one or more PDUs associated with a second flow using the second resource configuration. After 1206, on condition that a RTT between a first PDU of the one or more PDUs associated with the first flow and a second PDU of the one or more PDUs associated with the second flow is greater than the time threshold, the WTRU 102 may switch to transmitting one or more PDUs associated with the first flow using at least the third resource configuration at 1208.

In certain representative embodiments, the switching at 1208 may be determined (e.g., by the WTRU 102) to ensure synchronization between the flows. For example, the switch may be performed to meet a joint QoS for the flows as described herein.

In certain representative embodiments, the first resource configurations and/or the third resource configuration may include one or more CG configurations. In certain representative embodiments, the second resource configurations may include one or more SPS configurations.

In certain representative embodiments, the first resource configurations and/or the third resource configuration may differ in any of an offset time, a periodicity, payload size, and/or amount of time/frequency resources.

In certain representative embodiments, any one of first resource configurations and/or the third resource configuration may be associated with different priority levels as described herein.

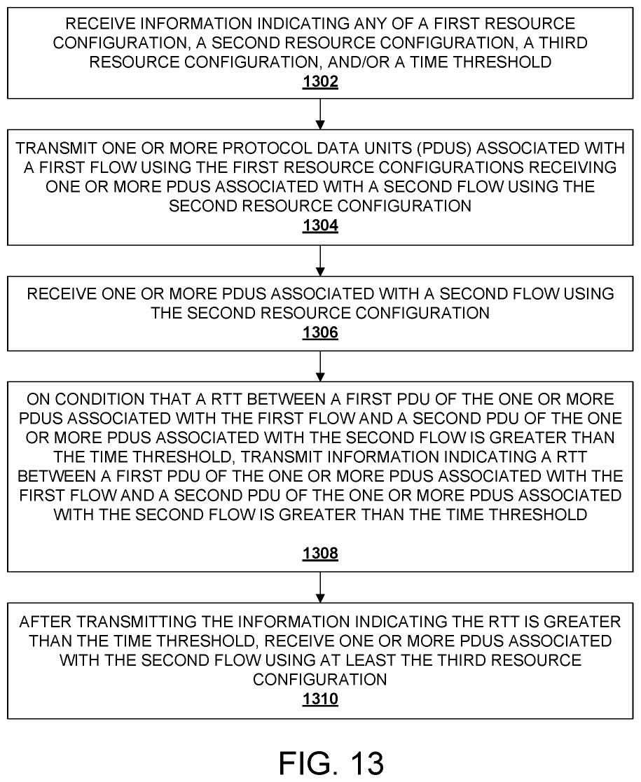

FIG. 13 is a procedural diagram illustrating a further example procedure for adjusting resource configuration information for synchronizing multiple flows. In certain representative embodiments, the procedure in FIG. 13 may be implemented generally by a WTRU 102, such as the WTRU 202. At 1302, the WTRU 102 may receive information indicating any of a first resource configuration, a second resource configuration, a third resource configuration, and/or a time threshold. At 1304, the WTRU 102 may transmit (e.g., forward to a base station) one or more PDUs associated with a first flow using the first resource configurations. At 1306, the WTRU 102 may receive (e.g., from the base station) one or more PDUs associated with a second flow using the second resource configuration. At 1308, on condition that a RTT between a first PDU of the one or more PDUs associated with the first flow and a second PDU of the one or more PDUs associated with the second flow is greater than the time threshold, the WTRU 102 may transmit information indicating the RTT between the first PDU of the one or more PDUs associated with the first flow and the second PDU of the one or more PDUs associated with the second flow is greater than the time threshold. At 1310, the WTRU 102 may, after 1308, receive one or more PDUs associated with the second flow using at least the third resource configuration.

In certain representative embodiments, the switching at 1208 may be determined (e.g., by the WTRU 102) to ensure synchronization between the flows. For example, the switch may be performed to meet a joint QoS for the flows as described herein.

In certain representative embodiments, the first resource configurations and/or the third resource configuration may include one or more CG configurations. In certain representative embodiments, the second resource configurations may include one or more SPS configurations.

In certain representative embodiments, the first resource configurations and/or the third resource configuration may differ in any of an offset time, a periodicity, payload size, and/or amount of time/frequency resources.

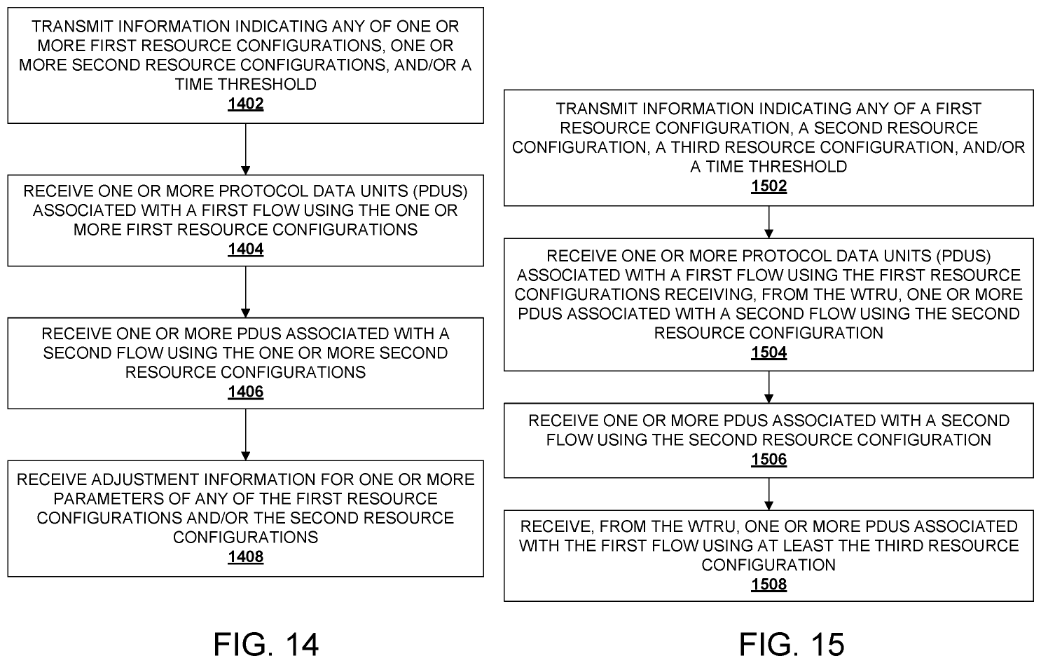

FIG. 14 is a procedural diagram illustrating an example procedure for adjusting resource configuration information for synchronizing multiple flows. In certain representative embodiments, the procedure in FIG. 14 may be implemented generally by a base station, such as a gNB 180. At 1402, the base station may transmit (e.g., to a WTRU 102) information indicating any of one or more first resource configurations, one or more second resource configurations, and/or a time threshold. At 1404, the base station may receive (e.g., from the WTRU 102) one or more PDUs associated with a first flow using the one or more first resource configurations. At 1406, the base station may receive (e.g., from the WTRU 102) one or more PDUs associated with a second flow using the one or more second resource configurations. At 1408, the base station may receive (e.g., from the WTRU) adjustment information for one or more parameters of any of the first resource configurations and/or the second resource configurations. For example, the adjustment information may be associated with a RTT between a first PDU of the one or more PDUs associated with the first flow and a second PDU of the one or more PDUs associated with the second flow being greater than the time threshold.

In certain representative embodiments, the adjustment information may be associated with one or more parameters of the resource configurations as described herein.

In certain representative embodiments, the adjustment information may be determined such as to ensure synchronization between the flows as described herein.

FIG. 15 is a procedural diagram illustrating another example procedure for adjusting resource configuration information for synchronizing multiple flows. In certain representative embodiments, the procedure in FIG. 15 may be implemented generally by a base station, such as a gNB 180. At 1502, the base station may transmit (e.g., to a WTRU 102) information indicating any of a first resource configuration, a second resource configuration, a third resource configuration, and/or a time threshold. At 1504, the base station may receive (e.g., from the WTRU 102) one or more PDUs associated with a first flow using the first resource configuration. At 1506, the base station may receive (e.g., from the WTRU 102) one or more PDUs associated with a second flow using the second resource configuration. At 1508, the base station may receive (e.g., from the WTRU 102) one or more PDUs associated with the first flow using at least the third resource configuration. For example, the use of the third resource configuration may be indicative (e.g., to the base station) of a RTT between a first PDU of the one or more PDUs associated with the first flow and a second PDU of the one or more PDUs associated with the second flow being greater than the time threshold.

In certain representative embodiments, adjustment information may be determined for any of the resource configurations as described herein. For example, the adjustment information may ensure the RTT satisfies certain requirements of the flows. For example, the adjustment information may modify one or more parameters such that synchronization between the flows is ensured as described herein.

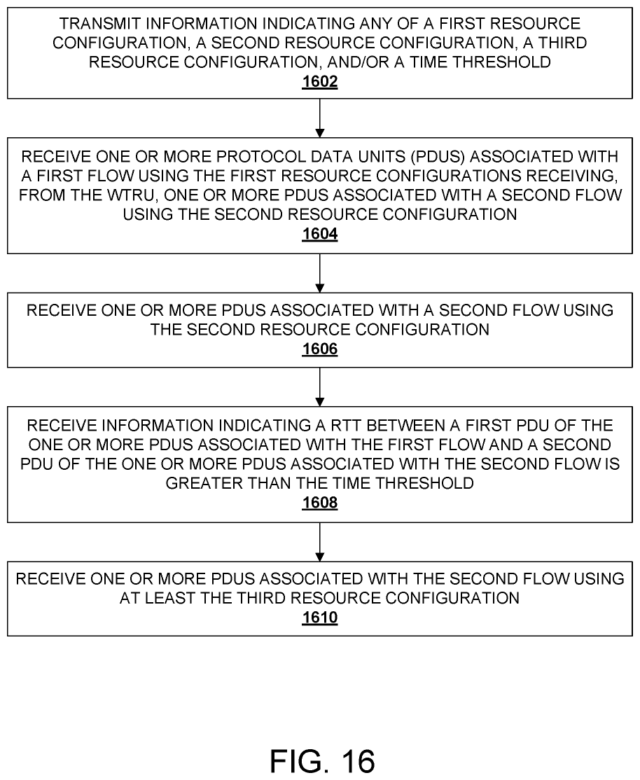

FIG. 16 is a procedural diagram illustrating a further example procedure for adjusting resource configuration information for synchronizing multiple flows. In certain representative embodiments, the procedure in FIG. 16 may be implemented generally by a base station, such as a gNB 180. At 1602, the base station may transmit (e.g., to a WTRU 102) information indicating any of a first resource configuration, a second resource configuration, a third resource configuration, and/or a time threshold. At 1604, the base station may receive (e.g., from the WTRU 102) one or more PDUs associated with a first flow using the first resource configurations. At 1606, the base station may receive (e.g., from the WTRU 102) one or more PDUs associated with a second flow using the second resource configuration. At 1608, the base station may receive (e.g., from the WTRU 102) information indicating a RTT between a first PDU of the one or more PDUs associated with the first flow and a second PDU of the one or more PDUs associated with the second flow is greater than the time threshold. At 1610, the base station may receive (e.g., from the WTRU 102) one or more PDUs associated with the second flow using at least the third resource configuration.

In certain representative embodiments, the use of the third resource configuration may ensure that synchronization of the flows is satisfied. For example, use of the third resource configuration may reduce the RTT between the first flow and the second flow.

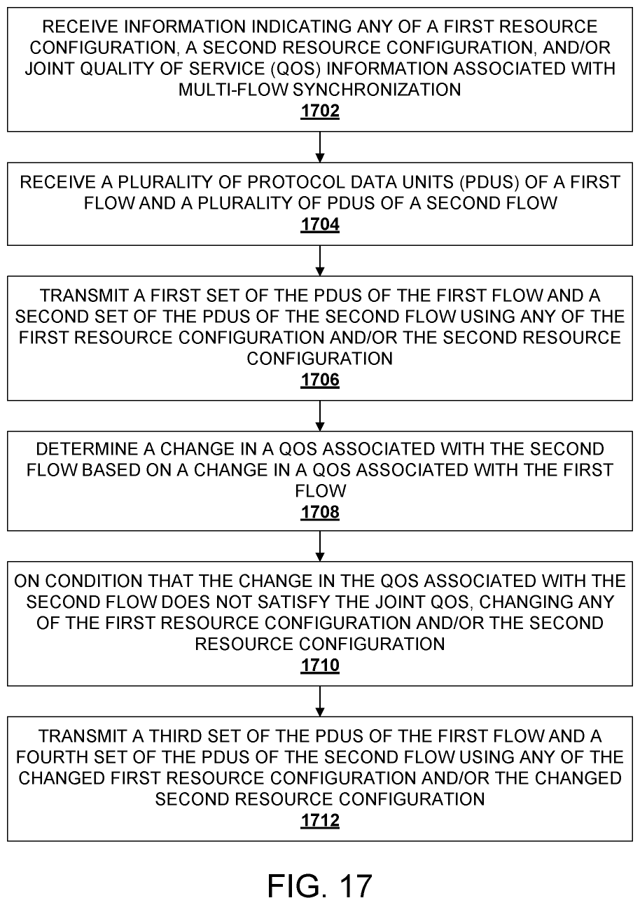

FIG. 17 is a procedural diagram illustrating an example procedure for maintaining a joint Quality of Service (QoS) for multiple flows. In certain representative embodiments, the procedure in FIG. 17 may be implemented generally by a WTRU 102, such as the WTRU 202. At 1702, the WTRU 102 may receive (e.g., from a base station) information indicating any of a first resource configuration, a second resource configuration, and/or joint quality of service (QoS) information associated with multi-flow synchronization. At 1704, the WTRU 102 may receive (e.g., from a base station) a plurality of PDUs of a first flow and a plurality of PDUs of a second flow. At 1706, the WTRU 102 may transmit (e.g., to a base station) a first set of the PDUs of the first flow and a second set of the PDUs of the second flow using any of the first resource configuration and/or the second resource configuration. At 1708, the WTRU 102 may determine (e.g., estimate) a change in a QoS associated with the second flow based on a change in a QoS associated with the first flow. At 1710, on condition that the change in the QoS associated with the second flow does not satisfy the joint QoS, the WTRU 102 may change any of the first resource configuration and/or the second resource configuration. At 1712, the WTRU 102 may transmit (e.g., to a base station) a third set of the PDUs of the first flow and a fourth set of the PDUs of the second flow using any of the changed first resource configuration and/or the changed second resource configuration.

In certain representative embodiments, the first resource configuration may be a first configured grant configuration, and/or the second resource configuration may be a second configured grant configuration. For example, a size of transmission occasions associated with the first resource configuration may be larger than a size of transmission occasions associated with the second resource configuration. For example, the first resource configuration may include (e.g., information indicating) a first plurality of transmission occasions having a first periodicity, and/or the second resource configuration may include a second plurality of transmission occasions having a second periodicity which is less than the first periodicity.

In certain representative embodiments, any of the first resource configuration and/or the second resource configuration may be associated with the first flow and/or the second flow.

In certain representative embodiments, the PDUs of the first flow and/or the second flow may be received from another WTRU 102 (e.g., using sidelink resources).

In certain representative embodiments, the PDUs of the first flow may comprise one or more ADUs of the first flow, and/or the PDUs of the second flow may comprise one or more ADUs of the second flow.

In certain representative embodiments, one or more of the PDUs of the first flow may include identification, timing and/or sequence information associated with the first flow. In certain representative embodiments, one or more of the PDUs of the second flow may include identification, timing and/or sequence information associated with the second flow. For example, the identification, timing, and/or sequence information may indicate a correspondence between the PDUs of the flows.

In certain representative embodiments, the joint QoS information may include any of a synchronization time window, a latency, and/or a data rate associated with multi-flow synchronization. For example, the joint QoS information may be associated with any of the first flow, the second flow, the first resource configuration, and/or the second resource configuration.

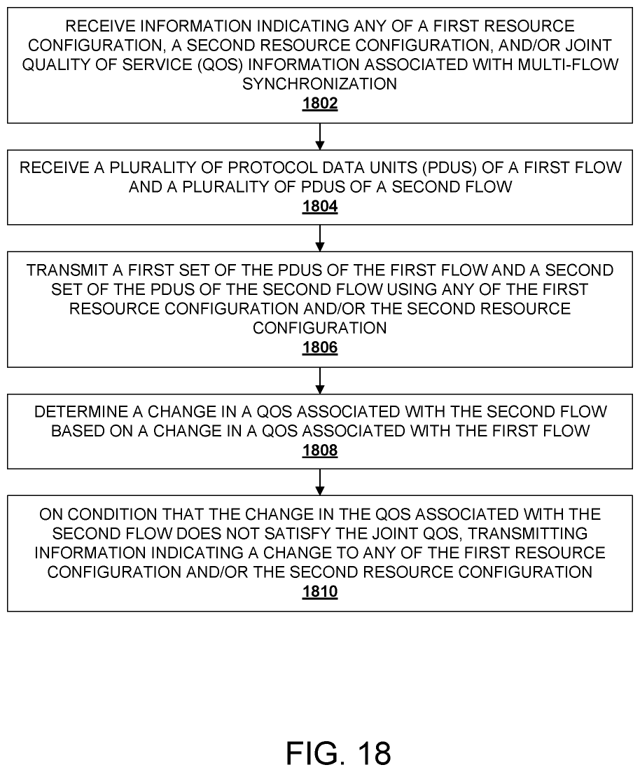

FIG. 18 is a procedural diagram illustrating another example procedure for maintaining a joint Quality of Service (QoS) for multiple flows. In certain representative embodiments, the procedure in FIG. 18 may be implemented generally by a WTRU 102, such as the WTRU 202. At 1802, the WTRU 102 may receive (e.g., from a base station) information indicating any of a first resource configuration, a second resource configuration, and/or joint quality of service (QoS) information associated with multi-flow synchronization. At 1804, the WTRU 102 may receive (e.g., from another WTRU 102 and/or higher layers) a plurality of PDUs of a first flow and a plurality of PDUs of a second flow. At 1806, the WTRU 102 may transmit (e.g., to a base station) a first set of the PDUs of the first flow and a second set of the PDUs of the second flow using any of the first resource configuration and/or the second resource configuration. At 1808, the WTRU 102 may determine (e.g., estimate) a change in a QoS associated with the second flow based on a change in a QoS associated with the first flow. At 1810, on condition that the change in the QoS associated with the second flow does not satisfy the joint QoS, the WTRU 102 may transmit (e.g., to the base station) information indicating a change (e.g., adjustment) to any of the first resource configuration and/or the second resource configuration.

In certain representative embodiments, the WTRU 102 may receive (e.g., from the base station) adjustment information associated with any of the first resource configuration and/or the second resource configuration. For example, the adjustment information may indicate changes to one or more parameters of any of the resource configurations. For example, the adjustment information may ensure that the joint QoS is satisfied for the flows.

In certain representative embodiments, the WTRU 102 may transmit (e.g., to the base station) a third set of the PDUs and a fourth set of the PDUs using any of the changed first resource configuration and/or the changed second resource configuration.

In certain representative embodiments, the first resource configuration may be a first configured grant configuration, and/or the second resource configuration may be a second configured grant configuration. For example, a size of transmission occasions associated with the first resource configuration may be larger than a size of transmission occasions associated with the second resource configuration. For example, the first resource configuration may include a first plurality of transmission occasions having a first periodicity, and/or the second resource configuration may include a second plurality of transmission occasions having a second periodicity which is less than the first periodicity.

In certain representative embodiments, any of the first resource configuration and/or the second resource configuration is associated with the first flow and/or the second flow.

In certain representative embodiments, the PDUs of the first flow and/or the second flow are received from another WTRU (e.g., using sidelink resources).

In certain representative embodiments, the PDUs of the first flow may comprise one or more ADUs of the first flow, and/or the PDUs of the second flow may comprise one or more ADUs of the second flow.

In certain representative embodiments, one or more of the PDUs of the first flow may include identification, timing and/or sequence information associated with the first flow. In certain representative embodiments, one or more of the PDUs of the second flow may include identification, timing and/or sequence information associated with the second flow. For example, the identification, timing, and/or sequence information may indicate a correspondence among the PDUs of the flows.

In certain representative embodiments, the joint QoS information may include any of a synchronization time window, a latency, and/or a data rate associated with multi-flow synchronization.

In certain representative embodiments, the joint QoS information may be associated with any of the first flow, the second flow, the first resource configuration, and/or the second resource configuration

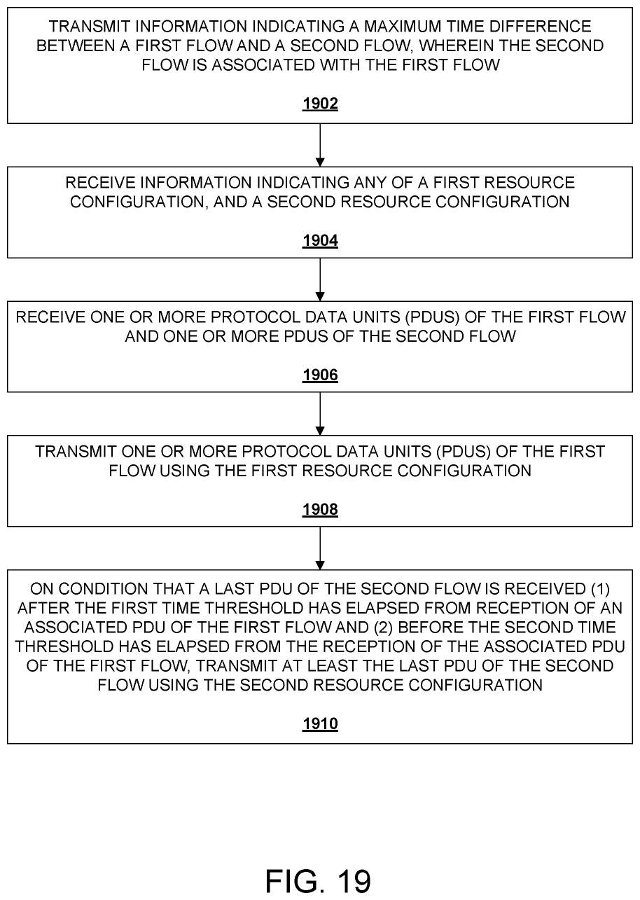

FIG. 19 is a procedural diagram illustrating further example procedure for synchronizing multiple flows. In certain representative embodiments, the procedure in FIG. 19 may be implemented generally by a WTRU 102, such as the WTRU 202. At 1902, the WTRU 102 may transmit (e.g., to a base station) information indicating a maximum time difference between a first flow and a second flow. For example, the second flow and the first flow may be associated with one another. At 1904, the WTRU 102 may receive (e.g., from a base station) information indicating any of a first resource configuration and/or a second resource configuration. At 1906, the WTRU 102 may receive (e.g., from another WTRU 102 and/or higher layers) one or more PDUs of the first flow and one or more PDUs of the second flow. At 1908, the WTRU 102 may transmit (e.g., to a base station) one or more PDUs of the first flow using the first resource configuration. At 1910, on condition that a last PDU of the second flow is received (1) after the first time threshold has elapsed from reception of an associated PDU of the first flow and (2) before the second time threshold has elapsed from the reception of the associated PDU of the first flow, the WTRU 102 may transmit (e.g., to the base station) at least the last PDU of the second flow using the second resource configuration.

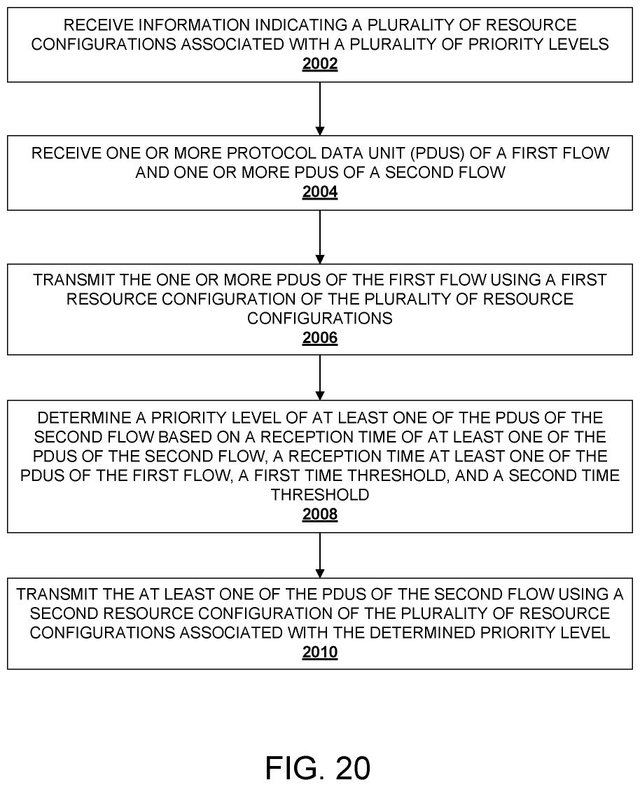

FIG. 20 is a procedural diagram illustrating a further example for transmitting multiple flows using priority levels. In certain representative embodiments, the procedure in FIG. 20 may be implemented generally by a WTRU 102, such as the WTRU 202. At 2002, the WTRU 102 may receive (e.g., from a base station) receiving information indicating a plurality of resource configurations associated with a plurality of priority levels. At 2004, the WTRU 102 may receive (e.g., from another WTRU 102 and/or higher layers) one or more protocol data unit (PDUs) of a first flow and one or more PDUs of a second flow. At 2006, the WTRU 102 may transmit (e.g., to a base station) the one or more PDUs of the first flow using a first resource configuration of the plurality of resource configurations. At 2008, the WTRU 102 may determine a priority level of at least one of the PDUs of the second flow based on a reception time of at least one of the PDUs of the second flow, a reception time at least one of the PDUs of the first flow, a first time threshold, and a second time threshold. For example, the priority level may be a first priority level when a difference in the reception times satisfies the first threshold. For example, the priority level may be a second priority level when a difference in the reception times satisfies the second threshold but not the first threshold. For example, the priority level may be a third priority level when a difference in the reception times does not satisfy the first threshold and does not satisfy the second threshold. At 2010, the WTRU 102 may transmit (e.g., to the base station) the at least one of the PDUs of the second flow using a second resource configuration of the plurality of resource configurations associated with the determined priority level.

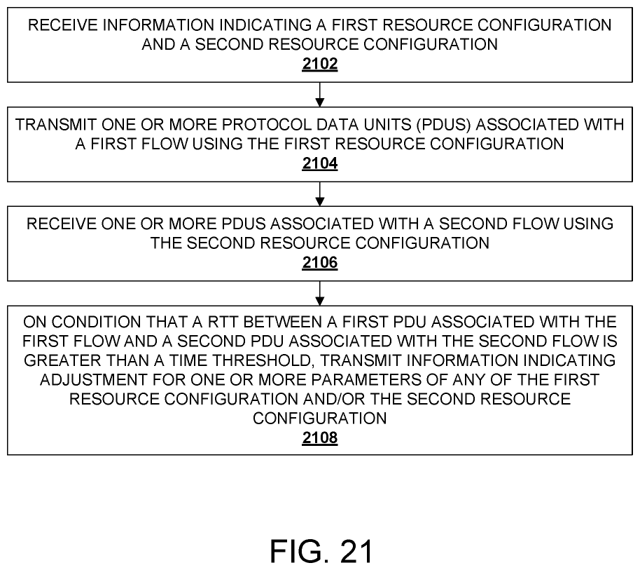

FIG. 21 is a procedural diagram illustrating a further example procedure for adjusting resource configuration information for synchronizing multiple flows. In certain representative embodiments, the procedure in FIG. 21 may be implemented generally by a WTRU 102, such as the WTRU 202. At 2102, the WTRU 102 may receive (e.g., from the base station) information indicating any of a first resource configuration and a second resource configuration. At 2104, the WTRU 102 may transmit (e.g., to the base station) one or more PDUs associated with a first flow using the first resource configuration. At 2106, the WTRU 102 may receive (e.g., from the base station) one or more PDUs associated with a second flow using the second resource configuration. At 2108, on condition that a RTT between a first PDU associated with the first flow and a second PDU associated with the second flow is greater than a time threshold, the WTRU 102 may transmit (e.g., to the base station) information indicating adjustment for one or more parameters of any of the first resource configuration and/or the second resource configuration.

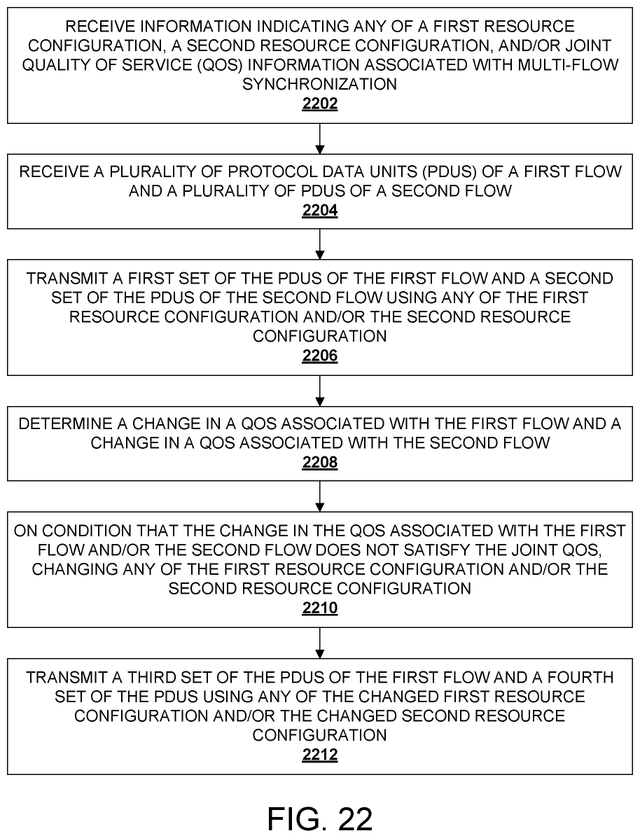

FIG. 22 is a procedural diagram illustrating an example procedure for maintaining a joint Quality of Service (QoS) for multiple flows. In certain representative embodiments, the procedure in FIG. 22 may be implemented generally by a WTRU 102, such as the WTRU 202. At 2202, the WTRU 102 may receive (e.g., from a base station) information indicating any of a first resource configuration, a second resource configuration, and/or joint quality of service (QoS) information associated with multi-flow synchronization. At 2204, the WTRU 102 may receive (e.g., from another WTRU 102 and/or higher layers) a plurality of PDUs of a first flow and a plurality of PDUs of a second flow. At 2206, the WTRU 102 may transmit (e.g., to the base station) a first set of the PDUs of the first flow and a second set of the PDUs of the second flow using any of the first resource configuration and/or the second resource configuration. At 2208, the WTRU 102 may determine (e.g., estimate) a change in a QoS associated with the first flow and a change in a QoS associated with the second flow. At 2210, on condition that the change in the QoS associated with the first flow and/or the second flow does not satisfy the joint QoS, the WTRU 102 may change one or more parameters of any of the first resource configuration and/or the second resource configuration. In another example, the WTRU 102 may select or receive another (e.g., third) resource configuration. At 2212, the WTRU 102 may transmit (e.g., to the base station) a third set of the PDUs of the first flow and a fourth set of the PDUs using any of the changed first resource configuration and/or the changed second resource configuration. In another example, the third and/or fourth set of the PDUs may be transmitted using other (e.g., third resource configuration).

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received before the first time duration has elapsed relative to the receiving of the first PDU, the WTRU 102 may send the second PDU using the second default forwarding configuration.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first time duration has elapsed relative to the receiving of the first PDU and before the second time duration has elapsed relative to the receiving of the first PDU, the WTRU 102 may send the second PDU using one of the plurality of forwarding configurations associated with a priority of the second flow which is higher than a priority associated with the second default forwarding configuration.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first time duration has elapsed relative to the receiving of the first PDU and after the second time duration has elapsed relative to the receiving of the first PDU, the WTRU 102 may send information indicating a reception status associated with the second PDU. The WTRU 102 may receive information indicating one of the plurality of forwarding configurations associated with the second PDU and/or the second flow. The WTRU 102 may send the second PDU using the indicated one of the plurality of forwarding configurations.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first time duration has elapsed relative to the receiving of the first PDU and after the second time duration has elapsed relative to the receiving of the first PDU, the WTRU may send information indicating a reception status associated with the second PDU. After, the WTRU 102 may receive information indicating to drop the second PDU.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that (1) a last PDU of the first ADU is received before the first time duration has elapsed relative to the receiving of the first PDU of the first ADU and/or (2) the second PDU of the second ADU is received before the first time duration has elapsed relative to the receiving of the first PDU of the first ADU, the WTRU may send the last PDU of the first ADU using the first default forwarding configuration and send the second PDU of the second ADU using the second default forwarding configuration.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. The WTRU 102 may receive a third PDU of the first ADU corresponding to the first flow. On condition that (1) the third PDU of the first ADU is received after the first time duration has elapsed relative to the receiving of the first PDU of the first ADU and before the second time duration has elapsed relative to the receiving of the first PDU of the first ADU and/or (2) the second PDU of the second ADU is received after the first time duration has elapsed relative to the receiving of the first PDU of the first ADU and before the second time duration has elapsed relative to the receiving of the first PDU of the first ADU, the WTRU 102 may send the third PDU using one of the plurality of forwarding configurations associated with a priority which is higher than a priority associated with the first default forwarding configuration and sending the second PDU using the second default forwarding configuration.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first and second time durations have elapsed relative to the receiving of the first PDU and before the third time duration has elapsed relative to the receiving of the first PDU, the WTRU 102 may send the second PDU using one of the plurality of forwarding configurations associated with a priority of the second flow which is higher than a priority associated with the second default forwarding configuration.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first and second time durations have elapsed relative to the receiving of the first PDU and before the third time duration has elapsed relative to the receiving of the first PDU, the WTRU 102 may send information indicating a reception status associated with the second PDU. The WTRU 102 may receive information indicating one of the plurality of forwarding configurations associated with the second PDU and/or the second flow, and the WTRU 102 may send the second PDU using the indicated one of the plurality of forwarding configurations.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first, second and third time durations have elapsed relative to the receiving of the first PDU and before the third time duration has elapsed relative to the receiving of the first PDU, the WTRU may send information indicating a reception status associated with the second PDU. The WTRU 102 may receive information indicating one of the plurality of forwarding configurations associated with the second PDU and/or the second flow, and the WTRU may send the second PDU using the indicated one of the plurality of forwarding configurations.

In certain representative embodiments, a WTRU 102 may receive information indicating first and second time durations and information indicating a plurality of forwarding configurations including a first default forwarding configuration associated with a first flow and a second default forwarding configuration associated with a second flow. The WTRU 102 may receive a first protocol data unit (PDU) corresponding to the first flow and may send the first PDU using the first default forwarding configuration. The WTRU 102 may receive a second PDU corresponding to the second flow. On condition that the second PDU is received after the first, second and third time durations have elapsed relative to the receiving of the first PDU and before the third time duration has elapsed relative to the receiving of the first PDU, the WTRU 102 may send information indicating a reception status associated with the second PDU. After, the WTRU 102 may receive information indicating to drop the second PDU.

In certain representative embodiments, a WTRU 102 may receive information indicating a plurality of resource configurations including a first resource configuration associated with a first flow and a second resource configuration associated with a second flow. The WTRU 102 may communicate (e.g., transmit or receive) a first protocol data unit (PDU) corresponding to the first flow using the first resource configuration. The WTRU 102 may communicate (e.g., transmit or receive) a second PDU corresponding to the second flow using the second resource configuration. On condition that a round trip time (RTT) associated with any of the first flow and/or the second flow is above a threshold, the WTRU 102 may determine a change to any of the first and/or second resource configurations to decrease the RTT below the threshold. Thereafter, the WTRU 102 may use any of the changed first and/or second resource configurations to transmit and/or receive one or more PDUs of any of the first and/or second flow. In other examples, the WTRU 102 may use QoS requirements in combination with or in place of the RTT.

In certain representative embodiments, a WTRU 102 may receive information indicating a plurality of resource configurations including a first resource configuration associated with a first flow and a second resource configuration associated with a second flow. The WTRU 102 may communicate (e.g., transmit or receive) a first protocol data unit (PDU) corresponding to the first flow using the first resource configuration. The WTRU 102 may communicate (e.g., transmit or receive) a second PDU corresponding to the second flow using the second resource configuration. On condition that a round trip time (RTT) associated with any of the first flow and/or the second flow is below a threshold, the WTRU may determine a change to any of the first and/or second resource configurations to increase the RTT above the threshold. Thereafter, the WTRU may use any of the changed first and/or second resource configurations to transmit and/or receive one or more PDUs of any of the first and/or second flow. In other examples, the WTRU 102 may use QoS requirements in combination with or in place of the RTT.

In certain embodiments and examples herein, procedures are described which may be performed for multi-flow synchronization on a per-PDU basis and/or a per-ADU basis. In other examples, multi-flow synchronization may be performed on a per-PDU set basis.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1.-46. (canceled)

47. A method implemented by a wireless transmit/receive unit (WTRU), the method comprising:
receiving configuration information associated with uplink (UL) traffic, the configuration information including information indicating a set of flows and a timer amount;
determining a set of arrival times and associated characteristics of a plurality of sets of protocol data units (PDUs) associated with the set of flows; and
sending, to a network entity, assistance information based on the timer amount expiring, wherein the assistance information includes UL traffic information indicating identifiers of the sets of PDUs, the determined set of arrival times and the associated characteristics of the sets of PDUs.

48. The method of claim 47, further comprising:
receiving a plurality of PDUs, included in the sets of PDUs, from an application executed by the WTRU.

49. The method of claim 48, further comprising:
sending the plurality of received PDUs as UL traffic, wherein at least one PDU of a respective set of PDUs includes information identifying a respective flow.

50. The method of claim 47, wherein the information indicating the set of flows includes a set of identifiers of the flows.

51. The method of claim 47, wherein the associated characteristics include any of a jitter amount or range associated with the sets of PDUs for a respective flow, and/or a periodicity associated with the sets of PDUs of a respective flow.

52. The method of claim 47, wherein the sets of PDUs are associated with the set of flows.

53. The method of claim 47, wherein the sets of PDUs comprise a plurality of application data units (ADUs), and the plurality of ADUs are associated with the set of flows.

54. The method of claim 47, further comprising:
determining a respective set of the PDUs is associated with a respective flow based on a header of a PDU of the respective set of the PDUs.

55. The method of claim 47, wherein the configuration information associated with the UL traffic is received via radio resource control (RRC) signaling.

56. The method of claim 47, wherein the assistance information associated with the application is sent via radio resource control (RRC) signaling.

57. The method of claim 47, further comprising: receiving, after sending the assistance information, resource configuration information associated with the set of flows.

58. A wireless transmit/receive unit (WTRU) comprising:
a processor, memory and a transceiver which are configured to:
receive configuration information associated with uplink (UL) traffic, the configuration information including information indicating a set of flows and a timer amount,
determining a set of arrival times and associated characteristics of a plurality of sets of protocol data units (PDUs) associated with the set of flows, and
send, to a network entity, assistance information based on the timer amount expiring, wherein the assistance information includes UL traffic information indicating identifiers of the sets of PDUs, the determined set of arrival times and the associated characteristics of the sets of PDUs.

59. The WTRU of claim 58, wherein the processor, memory and the transceiver are configured to:
receive a plurality of PDUs, included in the sets of PDUs, from an application executed by the WTRU.

60. The WTRU of claim 59, wherein the processor, memory and the transceiver are configured to:
send the plurality of received PDUs as UL traffic, wherein at least one PDU of a respective set of PDUs includes information identifying a respective flow.

61. The WTRU of claim 58, wherein the information indicating the set of flows includes a set of identifiers of the flows.

62. The WTRU of claim 58, wherein the associated characteristics include any of a jitter amount or range associated with the sets of PDUs for a respective flow, and/or a periodicity associated with the sets of PDUs of a respective flow.

63. The WTRU of claim 58, wherein the sets of PDUs are associated with the
set of flows.

64. The WTRU of claim 58, wherein the sets of PDUs comprise a plurality of application data units (ADUs), and the plurality of ADUs are associated with the set of flows.

65. The WTRU of claim 58, wherein the processor, memory and the transceiver are configured to:
determine a respective set of the PDUs is associated with a respective flow based on a header of a PDU of the respective set of the PDUs.

66. The WTRU of claim 58, wherein the configuration information associated with the UL traffic is received via radio resource control (RRC) signaling.

67. The WTRU of claim 58, wherein the assistance information associated with the application is sent via radio resource control (RRC) signaling.

68. The WTRU of claim 58, wherein the processor, memory and the transceiver are configured to:
receive, after sending the assistance information, resource configuration information associated with the set of flows.
